(19) United States
(12) Patent Application Publication
(10) Pub. No.: US 2011/0209087 A1
(43) Pub. Date: Aug. 25, 2011

(54) METHOD AND DEVICE FOR CONTROLLING AN INPUTTING DATA

(75) Inventor: Laurent Guyot-Sionnest, Paris (FR)

(73) Assignee: TIKILABS, Paris (FR)

(21) Appl. No.: 13/123,170

(22) PCT Filed: Oct. 7, 2008
(86) PCT No.: PCT/IB2008/002654

§ 371 Date: Apr. 7, 2011

(51) Int. Cl. G06F 3/048

(52) U.S. Cl. 715/799

(57) ABSTRACT

The present invention relates to a progressive multilevel interactively guided method and device for inputting to an apparatus any object among a set of up to N*N objects having each a symbolic representation, the small device comprising N sensible and N visual zones in correspondence one by one and having same form and relative positions, the method comprising the steps of showing N objects in each visual zone, a first actuation of the sensible zone associated with the visual zone showing the object to be selected, the distribution of the N shown objects in each N visual zones, a second actuation of the sensible zone associated with the visual zone showing the object to be selected, and an inputting of the selected object to the apparatus when the sensible zone is released. The objects symbolic representations are positioned within the visual zones in such a manner that the method is intuitive, easy to memorize and flexible, and via progressive levels, upward compatible with faster, chordic and less or no visual area demanding methods. The invention also relates to network systems using programs executing such methods and devices.

The present invention relates to the domain of command and data entry methods and devices (DEMD and DED) in an electronic apparatus, computer or other system, and more specifically to combinatorial methods working with a limited number of keys or sensitive zones providing flexibility from easy successive bi-tap solutions to fast simultaneous schemes and back or concurrent use thanks to an innovative, interactive and evolving screen guidance.

Many combinatorial and chording keyboards, in particular the one described in the French patent FR85/11532 (Guyot-Sionnest), are already known.

From the documents U.S. Pat. No. 4,344,069, US 2003/063775, U.S. Pat. No. 5,535,421, WO 97/23816 and “HP48 G Series User's Manual” the following are already known, respectively:
a device making it possible to generate characters by successively pressing two keys, where the character is produced upon raising the second key,
a device making it possible to evaluate and calculate three-dimensional distances in applications such as virtual keyboards,
a guiding device for a keyboard user where the guiding consists of displaying the production means activated by the user and the character produced by the means activated,
a computer method for user identification according to their behavioral profile, and
a user manual for a calculator which assigns several producible characters by a single key by means of one or more selection keys.

The first drawback of these reduced keys number solutions resides in the fact that they are not suited for being used both by a novice who is still learning the device's operation and an expert who seeks performance from the device. Moreover, in fact, because of its complexity and burden, the first step of discovering and learning chording keyboards always rebuffed the user who most often abandoned. No initial guidance or even adaptation as a function of the user's dexterity and hesitations are proposed.

In the past, only successive methods have been proposed to the general public, like the ubiquitous “multi-tap” methods found on mobile apparatus to enter text with a simple numerical pad (12 keys), or the “two-tap” methods found on half qwerty key pads (20 keys) or even “one-tap” on small qwerty pads (less than 40 keys). Every body, except some very young or old people can learn them and the big business of SMS proves it. But these input methods remain slow (below 20 words per minute for Latin alphabet languages) and for higher speeds the electronic industry is proposing micro qwerty solutions, but on a double area at least.

The main other drawback of these mass market solutions is that the vast majority of users have to look constantly at the small keys, which is attention consuming, uncomfortable and intrusive for others, without preventing a rather big errors rate.

On touch screens four solutions have been tried: numerical pads, micro qwerty pads, original pads and electronic inks. The main drawbacks of these different solutions are the following:
a rather big part of the screen is needed,
since the touch screen is flat, it is not easy to found a key-sensitive zone among many without looking closely at the zones,
when more than twelve keys are provided (minimum 35 keys for a micro qwerty), you have to look attentively at the keys and aim at them with attention to be able to tap without too many errors,
only one hand usage is difficult, and brings a lot of errors,
speeds remain low,
remote action brings little benefit, when it is possible, or when it needs a big keyboard additional device,
non qwerty special dispositions have to be learned and do not bring big enough benefits to compensate quickly enough the not so small learning effort,
these keyboards have a simple logic only for the first set of letters or signs, and remain just keyboards while commands and other navigation tools remain catered by separate means, both physically and logically, and
since you cannot stop looking to the keys and thinking to their logic, these keyboards are not really usable while on the move or while interacting with other people, which is a pity when you think that you always have these tools with you, and that they are connected to the world and more and more powerful.

When you are moving or not alone, none of the above solutions proposes any solution to interact with and input in an apparatus with either comfort, minimal focus of attention, flexibility to the context, speed, or minimal civility.

The present invention intends to remedy several drawbacks of the prior art for command and data entry methods and devices, in particular those using a small number of sensitive zones. The present invention makes it possible for the user to find benefits at the very beginning and a few weeks later, real expert performance. It offers an universal command and data entry method, whose sensitive zones can combine with a pointing device for graphical HMI, stay under a single hand or even under a single finger such as the thumb, are able to suit any computer or electronic apparatus and are based on the combined action broadly interpreted on a reduced number of sensitive zones capable of providing information with which ad hoc computer programs will be able to determine the position and movements of the fingers of one hand or of any actuator handled by the user. The successive or simultaneous activations of sensitive zones are interpreted by a program which can be configured according to the preferences and contexts in which the user is situated and will interpret tables populated for the user needs and preferences with computer objects, with their execution elements, at least one symbolic representation and at least one label of comments according to the known example of icons and scrolling menus for Graphical User Interfaces.

In particular the invention allows the mass market beginner to start in a few minutes while also allowing him to progress naturally with just useful use towards a very flexible method and, if sensitive zones allow it, towards a fast simultaneous mode, for any set of signs, commands and macros, with one and only one common rule.

Moreover, to perfect this integration of a multifunction HMI under the user's hand or finger for any computer or electronic apparatus, the invention integrates, in or next to sensitive zones, means for tracking the movements of one or several actuators and linking them to electronic pointers and associated cursors, according to the prior art.

To make it possible for the user to make use of the input devices and the means of production the best suited to each mobility context all while reusing the same designation reference tables for the objects, the invention introduces a canonical common symbolic representation mode linked to the universal morphology of the human hand. This canonical representation links the objects to be input to their positions in a N*N grid linked to the N sensible zones whose various activations will designate the different objects. It is even possible to advance that this symbolic representation of the objects positions constitutes in some way a writing system which could also have a cursive form or a points form, electronic, virtual or physical on paper or other media. This canonical symbolic representation moves away from prior writing systems which were built as a stylization of the designated object, in that it takes as a starting point a symbolic representation of the simple positioning possibilities of each finger of a human hand.

The method according to the present invention responds particularly well to the various needs of a person for discreet, comfortable and quick entry in any location, any position and any time, and for integration in small sized apparatus which are proliferating such as mobile telephones, personal assistants and multimedia listening and recording apparatus. The invention also makes it possible to provide a single method and device input and command solution which adapts equally well to the performance of a beginner, to that of an expert and to the various postures and constraints of a moving user, without requiring neither retraining nor a change of equipment.

It is understood that the technical aspects previously raised and amply described in what follows could be the object of a specific protection, each of these aspects being independently protected. Note the importance of:
the mechanisms making it possible to provide to the device the universal and personal functionalities making it possible to very flexibly control any electronic apparatus remotely controllable from the exterior,
technical mechanisms and means for the operation and interactive guiding making it possible to indicate, illustrate, and comment, on the screen or by audio or tactile means what positions of the fingers correspond to an object or a group of objects and to do that in a manner configurable according to the choices and performance of the user, from a continuous guidance to an optional guidance appearing when certain hesitations are perceived by the system,
technical mechanisms and means for learning and coaching the progression of the users' know how, from the moment of the unified command and input method discovery, to the phase where the user uses it reflexively and at maximum speed possible for the kinetic capacities of his hand and the tables of objects in memory, by moving through the updating of these tables according to the development of the users' needs, and the structuring of the most varied objects that can be activated in clusters and tables and can be represented in a symbolic manner common to the different modes of use of the DEMD,
the creation of an easy manuscript writing to be interpreted by electronic means, in real time or off-line, which supplements the DEMD and expands its advantages for a user,
the voluntarily redundant integration in an unequaled form of the keyboard, pointer and command functions under a single hand which remains nearly immobile and does not need repositioning or any delay to move from one mode to another mode for Interfacing between the Human and the Machine,
the capacity to replace the think-see-point-select-click type HMI like the mouse and the menu and scrollbar environments by the designation of objects, their exploration and their production with a think-see-click type HMI which becomes, after some use, a think-click type, infinitely faster. (every object can be input with a kind of keyboard shortcut),
the possibility of implementing a significant part of this method by simple software installation, on existing apparatus, for instance touch screen apparatus or apparatus with numerical pad, or with a pointer,
the possibility of implementing a significant part of this method by small programs called widgets or booklets associated with a browser and the Internet capability to combine (mash-up) small programs from various servers and make them read and played by the browser of any Internet connected apparatus the subscriber uses,
the possibility to manage centrally and to update in the background the personal parameters and choices of the user, on any apparatus he may use, with or without local software in the apparatus, with or without local software in the DEMD devices and accessories which the user carries with him all day long,
the possibility for providing high performance authentication, identification and encryption functions to a personal device without imposing to the user any felt constraints to use special additional security devices and rules.

For this purpose, the invention relates in its most general meaning to a method for inputting any object among a set of up to N*N objects to an apparatus with a data and commands input system comprising N sensible zones and a display screen on which there are N delineated visual zones, N being an integer above 3, each object having a symbolic representation, the visual zones being associated one by one with the sensible zones. This method comprises the steps of:
a first display of N visual zones each containing an indication for a subset of up to N objects of the set of up to N*N objects,
a first actuation of the sensible zone associated with the visual zone containing an indication of the object to be selected among the subset of up to N objects among said set of up to N*N objects,
a second display of N visual zones, in response to the first actuation of a sensible zone, to display the symbolic representations of the up to N objects of the subset indicated in the visual zone associated with the sensible zone which has been first actuated,
a second actuation of the sensible zone relatively positioned as the symbolic representation indicative of the object to be selected is positioned in visual zone(s).

This method is characterized in that:
the N visual zones are displayed in the same relative positions and forms as the N sensible zones,
before the first actuation, all the symbolic representations are arranged in each visual zone so that:
   all said symbolic representations indicative of the up to said N*N objects are displayed, up to N in each visual zone,
   the relative positioning of up to N symbolic representations in each visual zone is the same as the one of the N visual zones on the display screen,
   the up to N objects of each visual zone are positioned on an oriented curved line, linking up to N positions arranged in the corresponding visual zone in similar positions as the visual and sensitive zones, by following a pre-set order of the subset of up to N objects,
   in each of the N visual zones, the object which is selected by first and second actuations of the same sensible zone is also the first object of the corresponding subset of up to N objects, according to the pre-set order of said subset,
after the first actuation, the up to N symbolic representations initially displayed in the visual zone associated with the actuated sensible zone are now positioned in the N visual zones so that their resulting relative positioning is the same as the relative positioning of the symbolic representations initially displayed before the first actuation.

To facilitate a flexible handling of the DEMD by the user, the number N is computed to be as low as possible, and is the next integer above the square root of the biggest number of the biggest set of objects to be dealt by the DEMD. For instance N=6 to deal with the Latin alphabet of 26 letters, but could reach 7 for a small syllabic writing or 8 or 9 for bigger syllabic writings. Going above that numbers has some rationale, for instance to display together letters or syllables and numbers and special signs and some commands. But fast and blind handling of too many sensible zones will be difficult for many if they have to move hand and if they don't have enough tactile and kinesthezic feedbacks.

Subsequently, designation and validation of objects displayed in the N visual zone making the active cluster of up to N*N objects for the production or input of a given object will be discussed.

The invention recognizes that the general public has the universal reflex to tap or push a key where it sees an illustration of the “object” it wants to input. All standard keyboards are based on that universal reflex.

The easiest start for a new input method is then on touch screens where the N visual zones and the N sensitive zones are merged. Then to produce a given object among the up to N*N illustrations displayed in the N visual zones the invention proposes to tap the zone where it is displayed. But since there are up to N objects displayed in a given zone, the invention proposes to distribute the up to N objects of the activated sensitive zone associated to the visual zone in the N visual zones and to tap again the sensitive zone associated to the visual zone where the object is now displayed alone. As common in combinatorial methods, the object is produced when the actuator (finger) leaves the sensitive zone where it was “pushing”.

At that stage of the description, the process still look “bi-tap” but with some specific features.

But in the present invention, to deliver the above promised benefits, several future usage levels are anticipated and prepared by several counter intuitive and counter the state of the art solutions.

First, all up to N*N objects are displayed with their personal illustration, for preventing the need to think or guess what could be behind a common illustration for the up to N objects of a given visual zones. You see the wanted object and you push the sensitive and visual zones where it is displayed. No brainer and universal.

Second, each object is positioned in a given visual zone in accordance to the second sensitive zone which the user will have to push then release to finalize the production of the wanted object. To reach that, the visual zones are themselves positioned, shaped and displayed in a similar way as the sensitive zones are themselves. Although most sensitive zones disposition will be a matrix of C columns and L lines, several contexts or kind of users could ask different dispositions, like, if N=6, two columns of three lines on each side of an Internet Tablet, or a special disposition for an handicapped person and his limited free limbs.

And inside each visual zones the N positions where the objects illustrations will be displayed are positioned as the sensitive zones are. Therefore all users understand and “see” in advance what is the second sensitive zone, find it and learn and memorize in their brain and in their fingers the two sensitive zones with which they will produce a given object.

Third, the invention innovates in the way objects are positioned in the N*N positions built in the N visual zones, by not following the different well known standard ways to display signs and commands in physical keyboards and their visual variants, or the frequent principles applied by original methods. The invention does not display objects as a qwerty keyboard or as an [abcde . . . ] keyboard (with lines organized as a text). The invention does not display objects as original keyboards do, for instance to minimize finger or stylus travel or any such “speed” heuristic principle.

As a contrary, the invention will position objects in order to facilitate brain and fingers memories and future fingers reflex action. It has been observed for long that human memory easily memorizes paths and can follow them by doing them again, step by step, even when the conscious brain cannot fully describe the paths. For that, in each visual zone, will be positioned objects which have, as seen by the general user, something in common and which follow a well known preset order. The first object of the preset order will be positioned in the position which indicates that that object will be produced by pressing successively twice the same sensitive zone. The other objects will be positioned in the well known preset order on a well known oriented curved line, linking up to all N positions in the visual zone and finishing where the first object is positioned. That way, each user can more easily remember, in his brain and in his fingers, what is the first and second sensitive zones to activate. He first taps the first sensitive zone he remembers then finds in his fingers and brain what could be the second one, starting mentally with the first object of the up to N subset.

Moreover, on touch surfaces, including touch screen, user will be allowed to glide his actuator (stylus or finger) to change the activated second zone and look at the screen or at a special “helper” zone what is the object which would be produced if he would release the activated zone.

Moreover, he can glide outside the sensitive zones and up his actuator which means a “Null” selection which reset the process and display and does not produce anything.

If the sensitive zones are keys, they will often accept simultaneous tap, which means that several keys can be pressed simultaneously and each be fully seen by the computer program, and a Null or explore variant will be built in. For instance, either with a T0 time-out for the first actuation, or via a combined BackSpace and Reset sensitive zone, everything will come back to initial state and nothing will be produced, the only rule being of always maintaining one of the N sensitive zones activated until the BackSpace-Reset zone is activated and the BackSpace-Reset sensitive zone being the last to be released. To explore, just maintain at least one of the N sensitive zones physically activated and wait for the TO time out to elapse and to deactivate the previously physically released sensitive zone, the still physically activated zone becoming the first activated zone and all various displays adapting to that new status.

One big advantage of N being a small integer, (6 to 9 is enough for alphabetical and most syllabic languages), is that fingers tips and fingers will have a distinctiva different physical touch and kinesthezic sensations on the different sensible zones and then, if the sensation does not fit memory associated with the wanted object, global brain will be alerted and the mechanism above will allow the user to correct actuator position before releasing the last of the N sensitive zones. As a result, good physical sensations will be associated with wanted objects and will grandly accelerate global memorization. Moreover that stimuli being mostly dealt by back brains it will free visual focus of attention for the results on the screen or elsewhere of the objects input in the electronic apparatus, or for monitoring any important scene or landscape.

That benefit will be augmented by the fact that having a few visual zones or merged visual and sensitive zones on a touchscreen (N mainly between 6 and 9), will allow adapting their size to the sight and or the size of the user finger tips, including the thumb, or the stylus point. With one tap keyboards (like classical qwerty) each sign needs room to be legibly displayed and for the sensible zones to be separated from their neighbors, as needed by the actuator foot print. Usually, on standard touchscreen, that means that stylus is mandatory if you want to display all letters. With the invention, all N objects share the area of a visual zone and then they can be both usable by big fingertips and legible by poor sight users: the blank around objects illustrations is smartly shared.

Of course the solution of distributing the up to N objects in the N visual zones after the first actuation is a beginner solution, because the computer, the display and the mind of the user have to spend some extra milliseconds to adapt and, more important, the actuator hides what is being tapped on a touchscreen.

To compensate that last fact and to anticipate the complete non display of visual zones, the invention proposes the “helper” zone where it displays information about what can be produced with the current state of sensitive zones (idle state: it displays the common name of the cluster of up to N*N objects displayed in the visual zones, which are globally called “the current cluster”, for instance [abc] tells that the latin alphabet is currently proposed; when the first sensitive zone has been activated: it displays the content of the visual zone associated to that sensitive zone, for instance [abcde,] tells that with the first activation these six signs can now be produced, each with a different second sensitive zone; when the second sensitive zone is physically activated, i.e., pressed, the helper display the object, for instance [b] which would be produced when the sensitive zone would be released, or a description/explanation of it; when the last sensitive zone has been released the helper shows again the name of the current cluster of up to N*N objects, for instance [abc] or [123] (which may change, following the production of an ad hoc object in the invention program).

A step further, the up to N objects in the visual zone associated with the activated sensible zone, are no longer distributed in the N visual zones but the visual zone associated with the activated zone is first set in exergue then, when the second sensitive zone is activated, the object now fully designated is itself put in exergue in the first visual zone itself, and if the user glides its actuator on another sensitive zone, the object in exergue changes, until the sensitive zone is released and the object input, or until the actuator glides outside the main N sensitive zones and the system returns to the idle state. That display mode is similar with what happens on scrolling menus. There are variants for what happens to the N−1 other visual zones, either they remain unchanged, but the user can be confused, since he activates sensible zones associated to visual zones which display completely different contents than the object he wants, or the N−1 visual zones can be blanked to help user to concentrate on what is going on inside the first visual zone.

A big and counter intuitive step further consists to no longer display anything inside the visual zones. The user taps according to his brain and fingers memory. Astonishing as it is, the system of the invention is so well built in accordance with how human memories work together that ordinary people can tap a whole given cluster without any display after tapping it completely two or three times only.

When the visual zones and the sensitive zones are merged the system will still display the grid, to guide the actuators. But, since the area is no longer needed to display the representations of the objects, they could be diminished to just the area useful for a given actuator of a given footprint, index, thumb or stylus. Which already gives back some precious screen area.

If the operating system allows it, the whole visual and sensitive area could become transparent (just the grid and possibly the helper zone), which gives back the whole screen area.

When stylus is used, the grid can becomes the size of a big cursor and it will be advantageous to position the grid at the cursor position, the helper content being displayed as a water-mark in the grid as the stylus moves. Then the invention becomes a true and easy, because interactively guided, electronic ink, asking only very simple moves from the first sensitive zone to the second to produce letters, signs, commands, macros . . . whichever object is known by the electronic apparatus.

If the sensitive zones are distinct from the visual zones, then even the grid is not useful, just the helper. This is the standard situation of chord keyboards: you know your main clusters grammar and you can type without looking neither to the keys nor to the screen. But very few people in the 40 years since the inventor of the mouse, Doug Engelbart, also tried to promote one handed chord keyboards, have really succeeded, may be a few dozen of thousands, worldwide! With the invention, beginners start nearly at the opposite of chord keyboards but soon reap their big benefits just by using the present invention.

Of course, even genius cannot immediately memorizes all objects of all clusters (A standard PC can use up to eight hundred signs and commands), then the parameterized switch from the beginner display to the transparent mode will be progressive, cluster by cluster, some being never turned transparent because too sparsely used. Moreover, as soon as the user maintains a sensitive zone physically pressed more than a given time-out T5, then the full display reappears temporarily and only disappears when a valid production has been input.

All the contexts described above correspond to the usage of one actuator, being either an index, a thumb, a stylus or a pointing device. The advantages are that operation is easy and flexible for every body.

For instance, if the N sensitive zones are organized in two rows of three (N=6) or four zones (N=8), they can hold either under one hand and one thumb or two hands and two thumbs and can all be activated without any movement of the hands. With so few sensitive zones, each can be big enough to be easily activated without errors by a big thumb, and in the same time, the whole area is still small enough to fill no more than the half a standard phone touch screen (1.5 to 3 inches).

To operate a typical visual qwerty keyboard on a touchscreen of the same size, the stylus is nearly mandatory. Some can succeed with the nail of one thumb, but they have to look closely to find the center of each soft key, which slows them without preventing many errors. With big sensitive zones the user can quickly operate without really looking to the sensitive zones.

To input faster the user can work with two thumbs, the other moving while the first is tapping then releasing on a sensitive zone. Smaller movements of thumbs increase the comfort and easiness to tap without really looking to the sensitive zones.

To input more faster the user can put his three or four agile fingers above the sensitive zones. Now, each column of 2 zones can be dealt by one dedicated finger. Movements are now very simple and short which immediately benefits typing speed which on a simple bi-tap process with just one actuator is directly tied to the travel of the actuator above the area of the sensitive zones (McKenzie has created a formula to compute the highest typing speed for a given language and a given disposition of letters). Moreover the tactile and kinesthezic sensations associated to the three possible positions (front, back, up) are now very differentiated, which helps a lot to know whether your fingers are in the good positions for the production of a given object.

To exploit fully the hand position above the sensitive zones, it is useful that the sensitive zones can be activated simultaneously. The technology is now available in many hardware, like keys, touch pad or touchscreen. In the near future light beams or special gloves could enlarge the number of options.

With simultaneous capability built in the sensitive zones, the user will first discover that he don't need to release the first sensitive zone before taping the second.

Later he will ask how he could tap simultaneously the two sensitive zones and will discover that two objects share the same pair of sensitive zones: zone-i followed by zone-j and zone-j followed by zone-i. It is state of the art to use disambiguation software. It works, except for all unknown or abbreviated or wrongly spelled words. But it does not work for any set of N*N objects which are not, in the case of the unified user interface created by the invention, as meaningful as the alphabet and a given words corpus in a given language. Then the current invention, taking some ideas from WO 2006/053991 filed by Tiki'labs sas, will propose to add a third sensitive zone to one of the two objects that share the same pair of sensitive zones. If you take into account that you want to allow the user to bi-tap successively or simultaneously or to add the third sensitive zones after the tapping of the two main sensitive zones, the solution is nearly unique, after discounting symmetries. Of course, some simultaneous three chords will not be that easy to produce and users will durably produce the corresponding objects by keeping the bi-tap successive process. That flexibility is very important to leave the user act as he feels it, a given day, in a given context.

As already described in the WO 2006/053991, two time-out, T1 and T2 are mandatory to manage that optional third sensitive zone and the natural clumsiness of standard users, who are not piano or flute virtuosos.

T1 will tell whether two sensitive zones have been activated simultaneously (the order is not taken into account) or successively (the order is taken into account). When the two sensitive zones have been activated within T1, they are deemed simultaneous and the first object of the pair is automatically selected. If the user now wants to select the other object of the pair, then he has to, before releasing the activated sensitive zones, add the correct third key which will be hinted on the display, if he is not yet using a no display mode. Of course the user who anticipates that he wants the second object of a pair can either activate the two sensitive zones in more time than T1 and correct order or simultaneously activate the three sensitive zones. Which is what he will do within a few days and for his life long. Again, here the invention reaches standard chording, but with a very progressive learning path and visual help, when needed. T1 has to be large enough for a beginner if he wants to succeed in simultaneous activation, for instance 200 ms, but for expert, who do not want to wait to activate the second sensitive zone and still wants to use Bi-tap and to give tap order information to the computer program, T1 will be below 50 or even 30 ms.

The other side of simultaneous activation is simultaneous release of the sensitive zones. But, although it is easier to release simultaneously than to tap simultaneously, ordinary people cannot ever really release fingers simultaneously, as contacts and sensors see it. In milliseconds there will always be differences between the time of release of each sensitive zones. In the past, chord keyboards solved that problem by keeping, for the chord computation, all keys which had been activated, but it was a big constraint which prevented error correction and exploration. As described in PCT WO 2006/053991, the T2 time out concept solves the problem by smoothing naturally rough, clumsy and irregulars fingers movements.

For each physical sensitive zone, a logical zone is created in the program, and a clearing time out delay T2 is associated with each logical zone. When the physical sensitive zone is released, its time out count down is triggered. The logical zone will be deactivated at the expiration of this time delay. Thereby, when all physical sensitive zones are seen as free, only the logical zones which are still active, meaning those for which the clearing time delay has not expired, will be considered to compute the object to be produced. Moreover, when a time out is not expired, the display take into account the logical zone to compute what has to be displayed, and when the time out expires, the display adjusts to the currently activated logical zones. Then the T2 time out mechanism and the logical zones concept bring two very important benefits, first, users can release sensitive zones without problems and get exactly what they want, secondly, they can explore and get visual feedback on the screen and in the helper zone before releasing the last sensitive zones. When all physical sensitive zones are released, after computing the object associated with the still activated logical zones, all the time out are cleared to separate clearly the finished production from the following one. T2 time delay can take value of up to 200 ms for a beginner but will be set below 50 ms for an expert of a few days.

According to preferred embodiments:
The visual zone associated with the first actuated sensible zone and the up to N objects of the subset in the first visual zone are put in some exergue indicative of the first actuation, to guide users and tell them their action has been seen by the device and computer.
The visual zone associated with the second actuated sensible zone and the designated object are put in some exergue indicative of the second actuation, to guide users and tell them their action has been seen by the device and computer.
The putting in exergue of the display zone associated with the first actuated sensible zone and the second display are produced as soon as a sensible zone is first actuated, to inform quickly the user.
The putting in exergue of the display zone associated with the first actuated sensible zone and the second display are produced when the sensible zone which has been first actuated is released, to allow exploration by the user before he releases the actuator.
The selected object is inputted to the apparatus when the sensible zone which has been second actuated is released, to allow exploration by the user before he releases the actuator and to prepare to simultaneous release which is much more easier to do and to correctly interpret by the computer program.
The second actuation is obtained by gliding the actuator which has first actuated a first sensible zone to a second sensible zone corresponding to the initial position in the first actuated sensible zone of the symbolic representation indicative of the object to be selected, because that mode, mimicking handwriting, is very natural to human, and when objects are no longer displayed, very quick and effective, moreover with other features, it facilitates exploration and correction.
The second actuation is obtained by maintaining with a first actuator the sensible zone which has been first actuated and by actuating with a second actuator the second sensible zone corresponding to the initial position in the first actuated sensible zone of the symbolic representation indicative of the object to be selected, and the inputting of the selected object to the apparatus is obtained by releasing said first and second actuators. This feature allows nearly one cycle, therefore faster, object inputting and prepares to simultaneous action.
The oriented curved line is built according to the trigonometric inverse order, which is the most universally known, and everybody can manage it mentally when objects are not displayed.
The first actuation drops out after a threshold TO time delay, to allow fast error correction: an expert will use T0 below ½ second because he does not need more time to jump to the second sensitive zone.
The first and second activations drop out by tapping or gliding an actuator outside the sensible zones and releasing said actuator after others and sensible zones have been released, to allow fast error correction before any production.
A visual helper zone is displayed on the display screen, first to display indications when the actuator hides the visual-sensitive zone, second to display indications when the objects themselves are not displayed, to get back the screen area an to get quicker action from the computer.
The up to N symbolic representations in the first visual zone are no longer positioned in the N visual zones after the first actuation if the user knows enough the sequences of two actuations to produce the objects to be selected with just the guiding provided by the interactive putting in exergue of visual zones and objects, to go quicker when the user no longer needs beginner guiding, and to compensate the fact that the actuator hides the wanted object symbolic representation.
The visual zones are reduced or/and their inside area put into transparency without displaying the symbolic representations of the objects, if the user knows the sequences of two actuations to produce the objects to be selected, to get back the useful and scarce screen area and allow quicker action from the computer.
The first and second actuations are made simultaneously and an additional disambiguation third sensible zone is added to select one combination among the two combinations that are obtained by successive actuations of same two sensible zones, for quicker input indeed.
A threshold time delay T1 allows to separate between simultaneous and successive activation of two sensible zones and a threshold time delay T2 allows to forget deactivated sensible zones and not take them into account to compute what is displayed and put in exergue in the display zones and input in the apparatus when all sensible zones are found released. These two time delays and associated mechanisms are mandatory for the vast majority of users who are not virtuosos.
The addition of a third sensitive zones to disambiguate between two combinations using the same pair of sensitive zones is guided on the display zones, before any activation, after the simultaneous press of two zones and after the addition or release of the third zone. Without interactive guiding, only a few users would upgrade to the simultaneous action. It is needed just a few days in a life time but it is nearly mandatory.
The objects include at least one among a set of computer and electronic objects, alphanumeric characters, words, signs, standard phrases, icons, scrolling menu items, commands and programs internal to the apparatus, commands, programs and services stored with their parameters and provided by at least one among a third party program and service providers external to the apparatus and residing on any other apparatus, computer and electronic equipment to which the apparatus is connected, or through smart personal widgets working via a browser and Internet connections to ad hoc servers and analyzing the user actions on sensible zones and Internet pages. This DEMO is aimed at becoming universal and unified for its users, and as a software “keyboard”, can do it.
The symbolic representations of the objects include at least one among a set of letters, words, graphical symbols, image icons, and an explanation commentary. The explanation commentary is very useful for sophisticated objects, for instance when they are proposed in accordance to the context.
After at least one among first and second actuations, at least one sensitive signal is emitted to give a feedback of the actuation to the user. It is about using the DEMD when user cannot look at a screen but has several senses available.
It includes the creation of a cluster of suggestions including at least one and up to N−1 suggestions, said cluster being displayed in the N visual zones, the selection among the suggestions being made by actuating and releasing the sensible zone associated with the visual zones where the suggestion that suits the user is displayed.
The appearance and fading out of the visual zones is controlled by one among computer programs, parameters chosen by the user and scripts and events embedded in a web page when the apparatus is connected to a web page. Most of the time, the expert user don't use visual zones, but he has some usage for them, when he hesitates or when the system want to communicate to him and as with completion hints, gets answers in the same unified process inside its natural flow.

The invention also relates to a computer program intended to implement such a method and including a plurality of instructions suited to process the information coming from the actuation, to display information on the display zones and to input to the apparatus an object as a function of the actuated sensible zones.

The invention also relates to a device for inputting to an apparatus any object among a set of up to N*N objects, comprising N sensible zones and a display screen on which there are N delineated visual zones, N being an integer above 3, each object having a symbolic representation, the visual zones being associated one by one with the sensible zones. This device makes it possible to execute the following steps:
a first display of N visual zones each containing an indication for a subset of up to N objects of the set of up to N*N objects,
a first actuation of the sensible zone associated with the visual zone containing an indication of the object to be selected among the subset of up to N objects among said set of up to N*N objects,
a second display of N visual zones, in response to the first actuation of a sensible zone, to display the symbolic representations of the up to N objects of the subset indicated in the visual zone associated with the sensible zone which has been first actuated,
a second actuation of the sensible zone relatively positioned as the symbolic representation indicative of the object to be selected is positioned in visual zone(s),

This device is characterized in that:
the N visual zones are displayed in the same relative positions and forms as the N sensible zones,
before the first actuation, all the symbolic representations are arranged in each visual zone so that:
   all said symbolic representations indicative of the up to said N*N objects are displayed, up to N in each visual zone,
   the relative positioning of up to N symbolic representations in each visual zone is the same as the one of the N visual zones on the display screen,
   the up to N objects of each visual zone are positioned on an oriented curved line, linking up to N positions arranged in the corresponding visual zone in similar positions as the visual and sensitive zones, by following a pre-set order of the subset of up to N objects,
   in each of the N visual zones, the object which is selected by first and second actuations of the same sensible zone is also the first object of the corresponding subset of up to N objects, according to the pre-set order of said subset,
after the first actuation, the up to N symbolic representations initially displayed in the visual zone associated with the actuated sensible zone are now positioned in the N visual zones so that their resulting relative positioning is the same as the relative positioning of the symbolic representations initially displayed before the first actuation.

According to preferred embodiments:
Sensible zones are actuated with a pointing device which is both universally available (mouse, touchpad) and can be very quick and natural with a stylus on touch surfaces.
Sensible zones are actuated with at least one finger.
Relative positions of sensible zones are arranged under one hand and under fingers so that each sensible zone can be reached without moving the hand but only the fingers. That important feature is prepared by N/3 being small.
Relative positions of sensible zones are arranged under one hand and under fingers so that each sensible zone can be reached with the thumb of the only hand that holds the device. That feature is nearly impossible with visual classical keyboards on touch screens.
Sensible zones are a part of the area of the visual zones, when the visual zones are on a touchscreen.
The N sensible zones and the display screen are built as parts of a common block of the apparatus, because most users want one object in their pockets, cases and bags.
At least the sensible zones can be separated from the main apparatus to be used at a distance from said apparatus, but most users want also to be able to use “screens” and “apparatus” at a distance, with a remote.
The device further includes additional sensible zones and corresponding additional visual zones for shift functions of objects or of N*N objects and production of an object by individual actuation, to increase power and speed.
The device further includes an electronic chip type and methods means for authentication of the device and its user, and for the production of encrypted alphanumeric strings, either according to its own program, the user's usage profile or from characters strings input by the user, said means being specific to said device. This feature alone is very important to reach secure distant access to servers, for both parts.
The device further includes a pointer mechanism built with technologies among the actuators positions detectors of the device, a juxtaposed pointer device and a mouse device under the DEMD device, because, when you are at a distance, you need a pointer and because the smallness and without looking features of the DEMD allow this unthinkable combined device.

The invention also relates to a data entry system including computing equipments and at least one such device for inputting any object among a set of up to N*N objects, said data entry system piloting said computer equipments through the inputted objects.

The invention also relates to a network system using at least one such computer program intended to implement such a method of inputting any object among a set of up to N*N objects to an apparatus, said computer program, when the apparatus including such a device is connected to the network, being built from parts found on servers on the network, in the apparatus and in the device, said network system using browsers and making it possible to exchange data between said parts of the computer program to be built so that the implementation of said method is optimized.

The invention will be better understood with the help of the description, made below purely for explanation, of an embodiment of the invention by reference to the attached figures where:

FIGS. 1, 2, and 3 show different embodiments of the present invention,

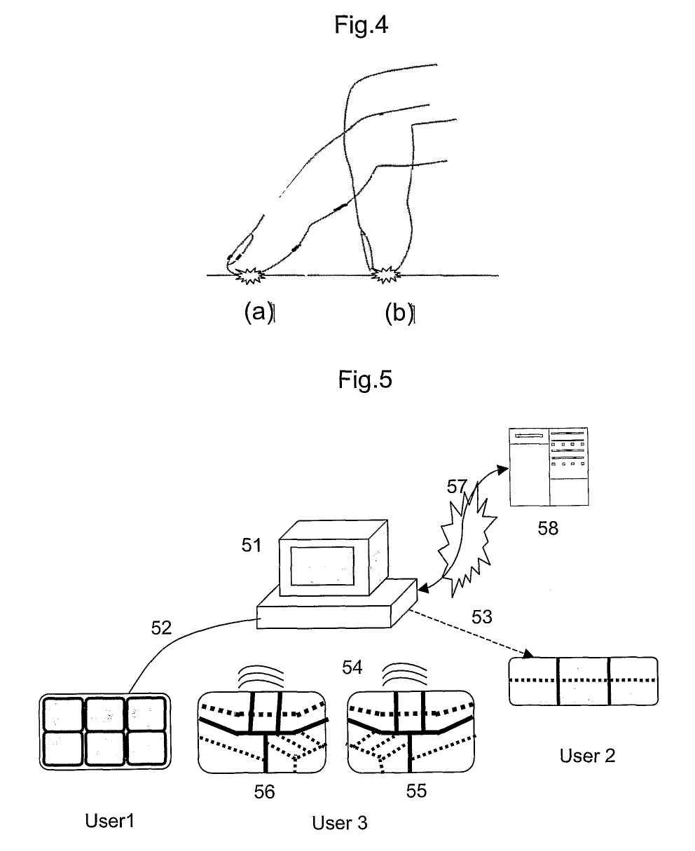

FIG. 4 illustrates an example of tactile feedback, provided by the two different positions of the fingertips, during the use of the present invention,

FIG. 5 illustrates a system according to the present invention in which three users interact with an apparatus connected to the Internet or any network,

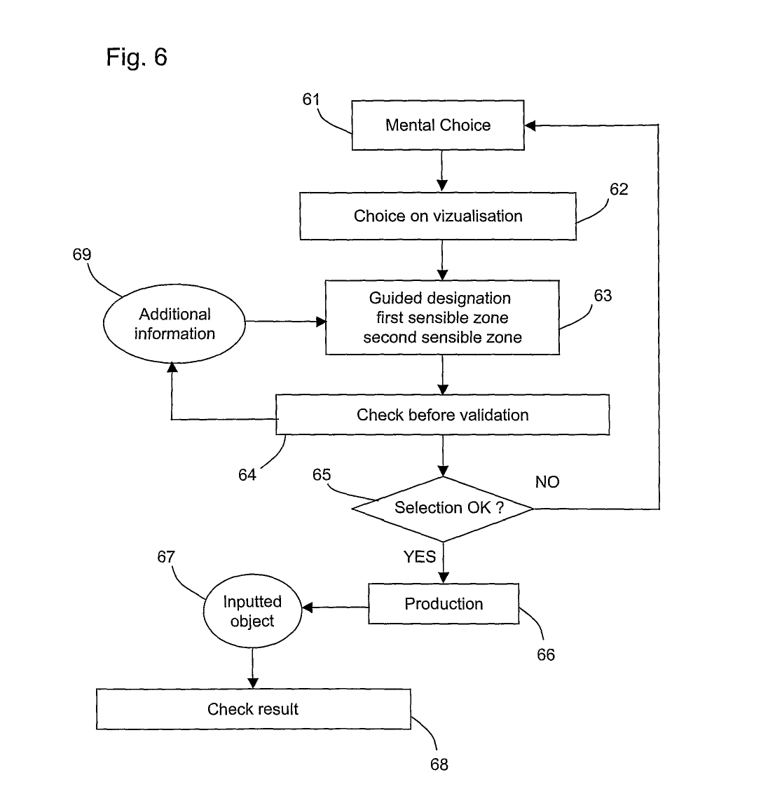

FIG. 6 is a flow diagram of the production of an object according to the present invention,

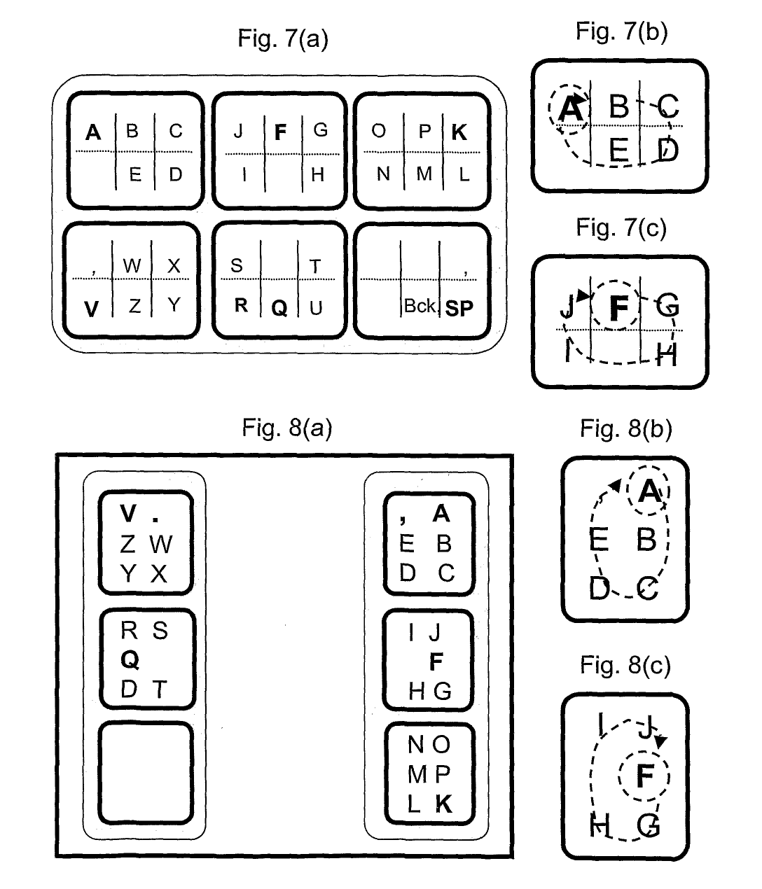

FIGS. 7(a) to 7(c) show interactive visual guiding means for the selection of objects according to a first example of the present invention where N=6,

FIGS. 8(a) to 8(c) show interactive visual guiding means for the selection of objects according to a second example with a different positioning of 6 visual zones,

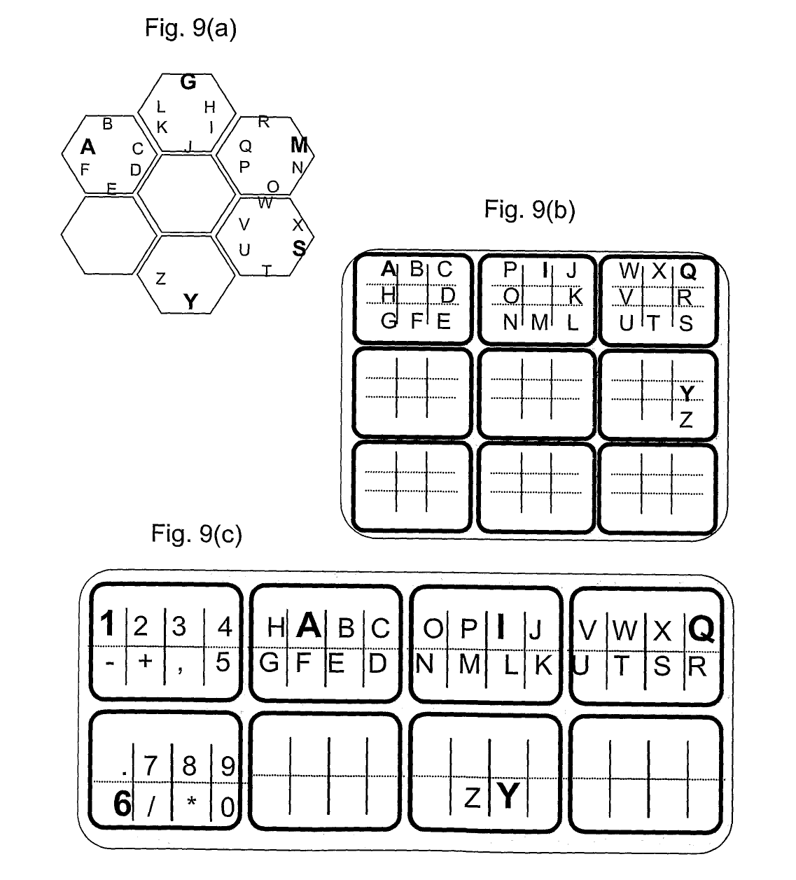

FIGS. 9(a), 9(b) and 9(c) show three examples of the present invention for N=7, 9 and 8,

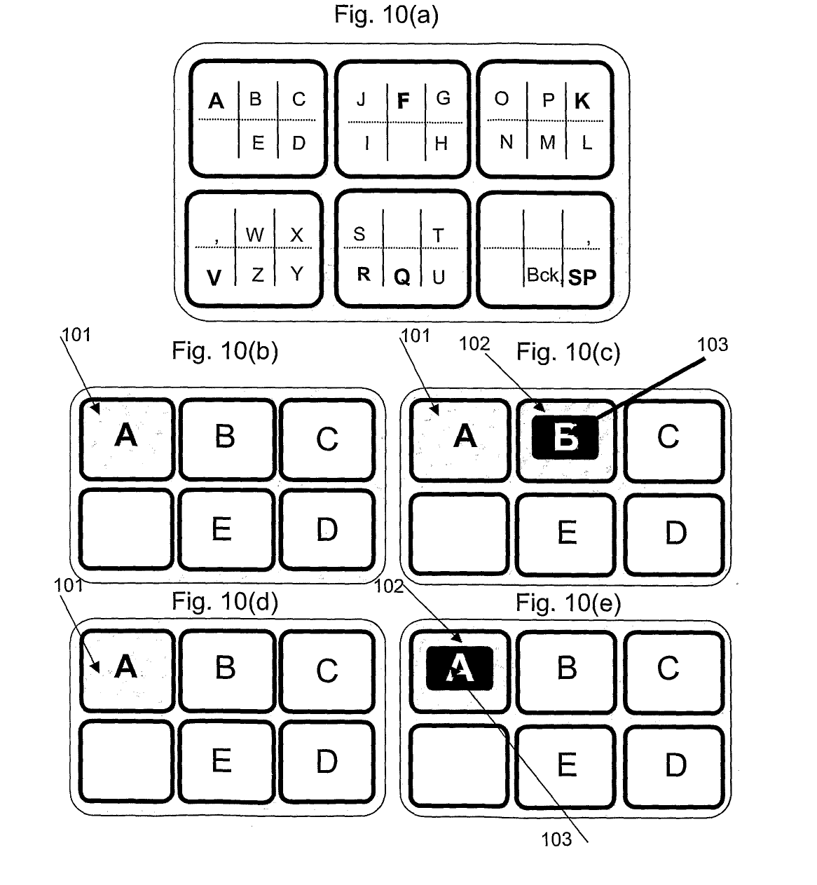

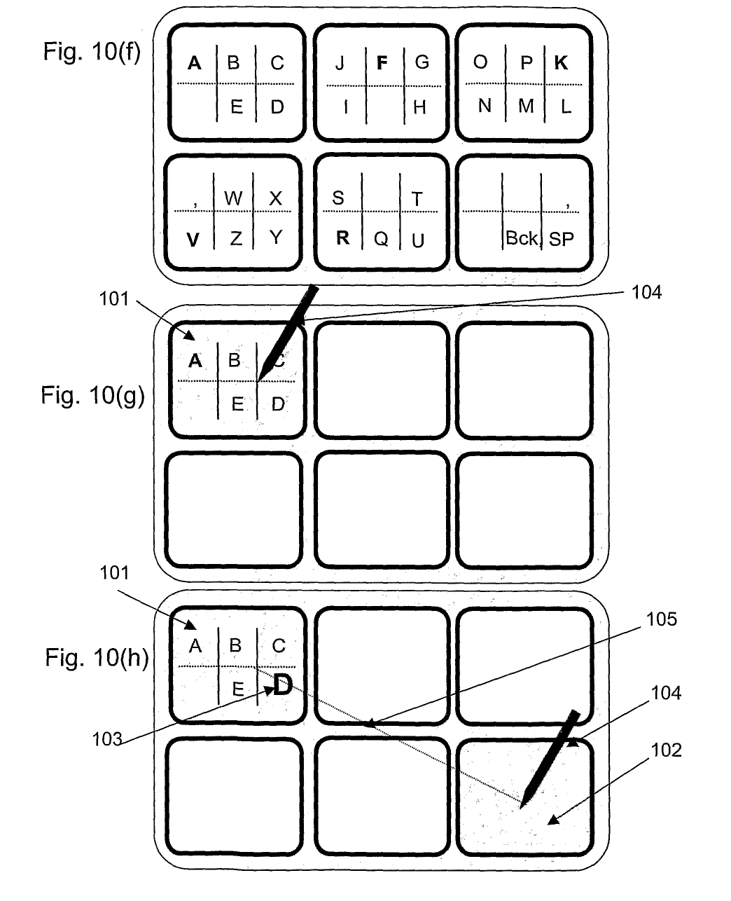

FIGS. 10(a), 10(b) to 10(c) and 10(d) to 10(e) and 10(f) to 10(h) show how the production, guiding and putting in exergue are made, with different modes and actuators,

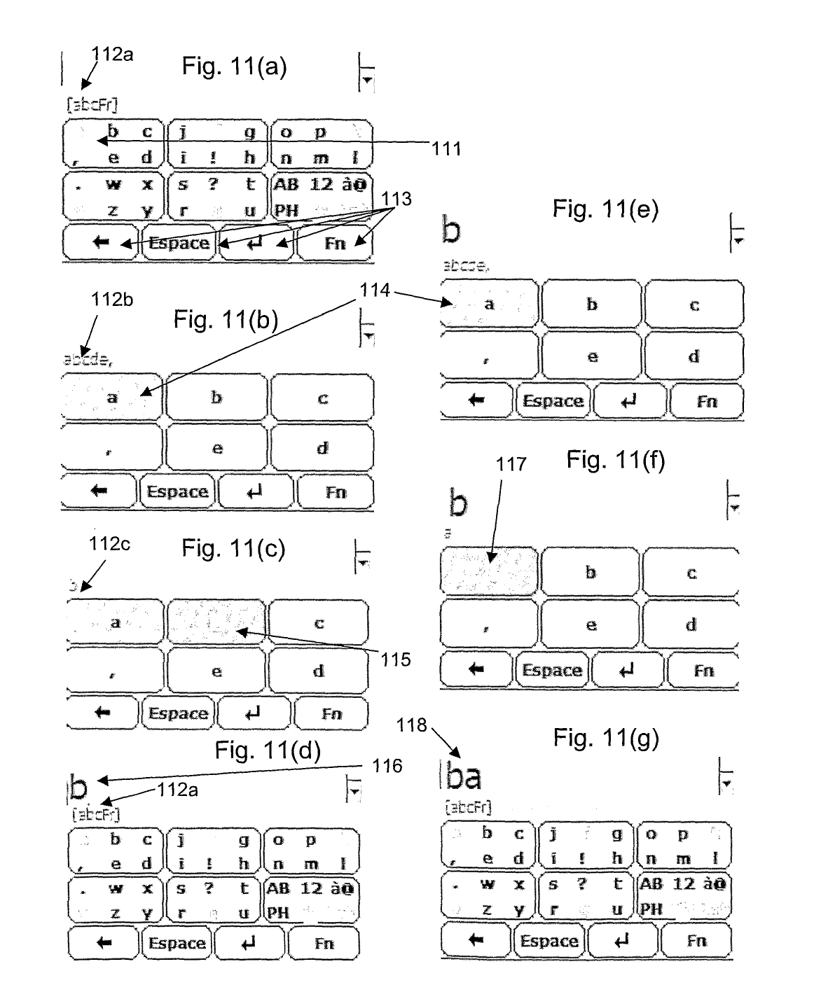

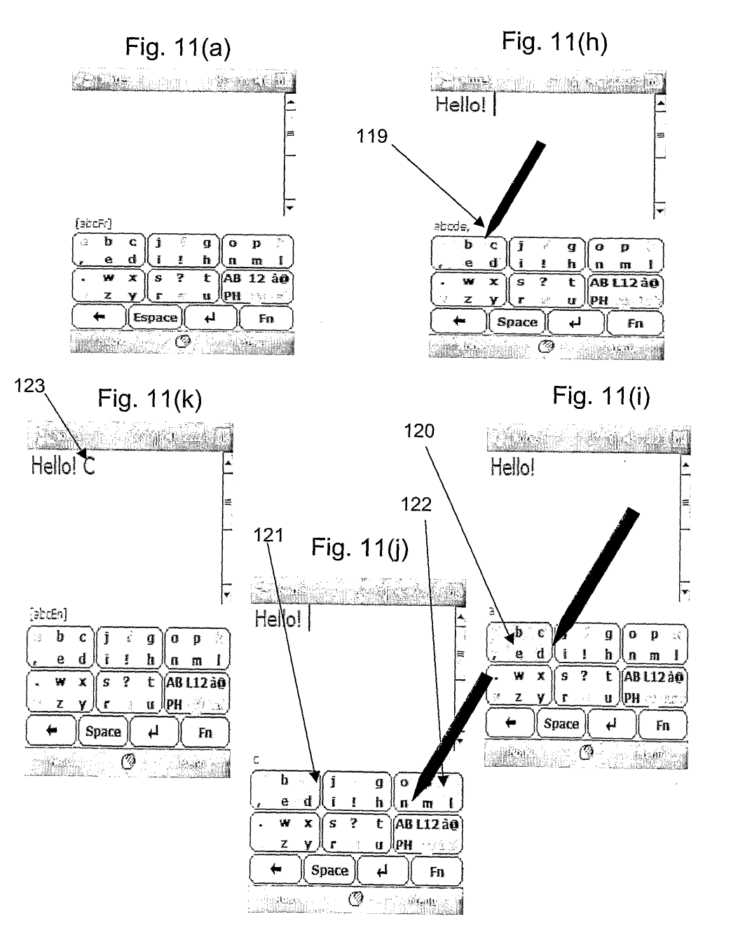

FIGS. 11(a) to 11(g) and 11(h) to 11(k) show screenshots of the method to input two different characters according to the first example of the present invention, and for different ways for putting zones and selected objects in exergue,

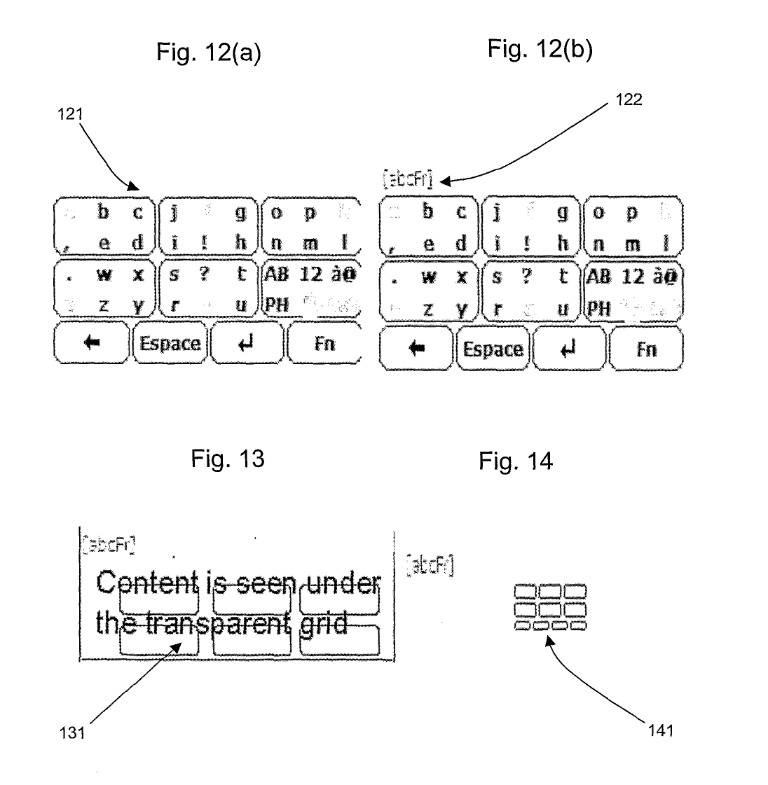

FIGS. 12(a) and 12(b) illustrate the possibility to display an helper zone on the display screen,

FIG. 13 shows a cluster wherein the objects are no longer displayed in the visual zones, becoming a transparent grid, when the user is accustomed enough,

FIG. 14 shows a cluster wherein the visual zones are displayed on a smaller grid when no graphical symbols are displayed and a stylus used,

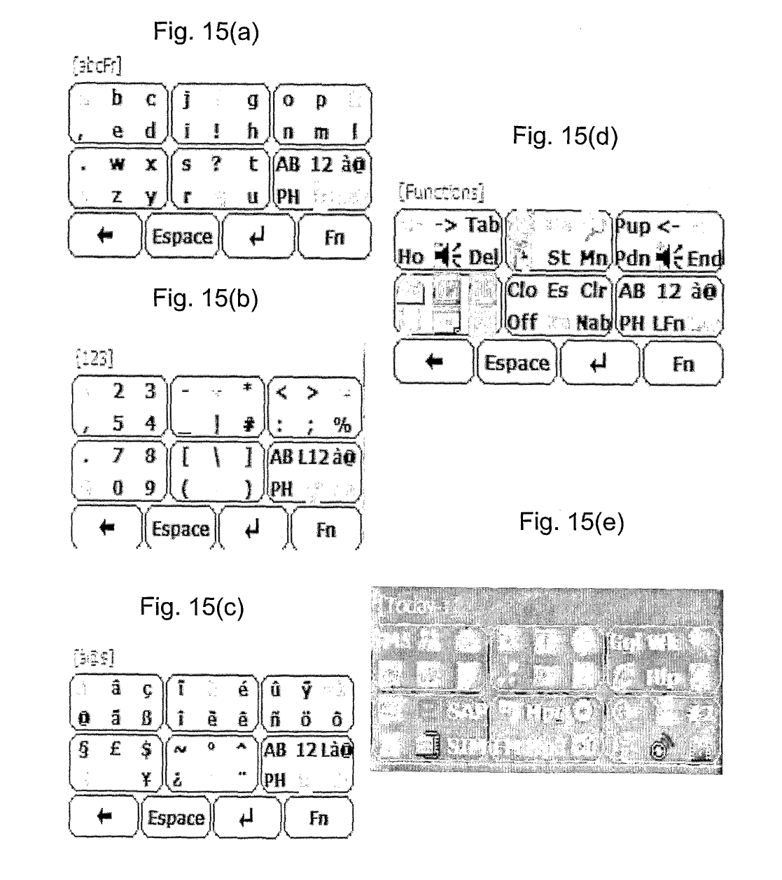

FIGS. 15(a) to 15(e) show different examples of clusters that may be used in accordance with the invention,

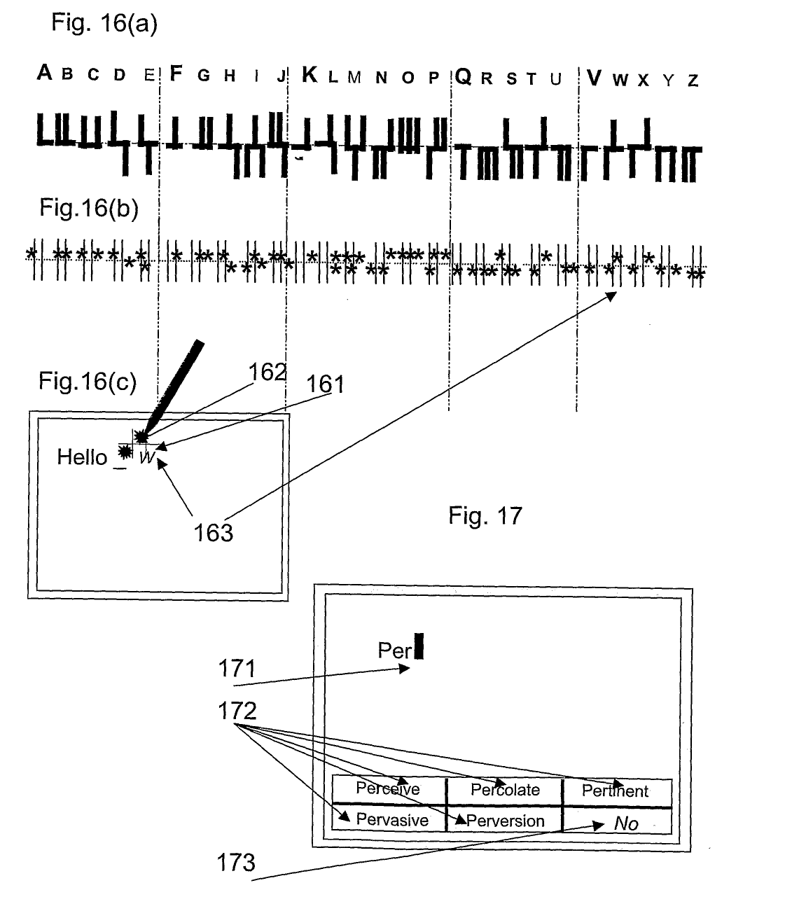

FIGS. 16(a) to 16(c) illustrate several written forms, cursive and by points, in fact created by the invention,

FIG. 17 illustrates how visual guiding in N visual zones makes it possible to increase the usefulness of semantic correction and prediction software,

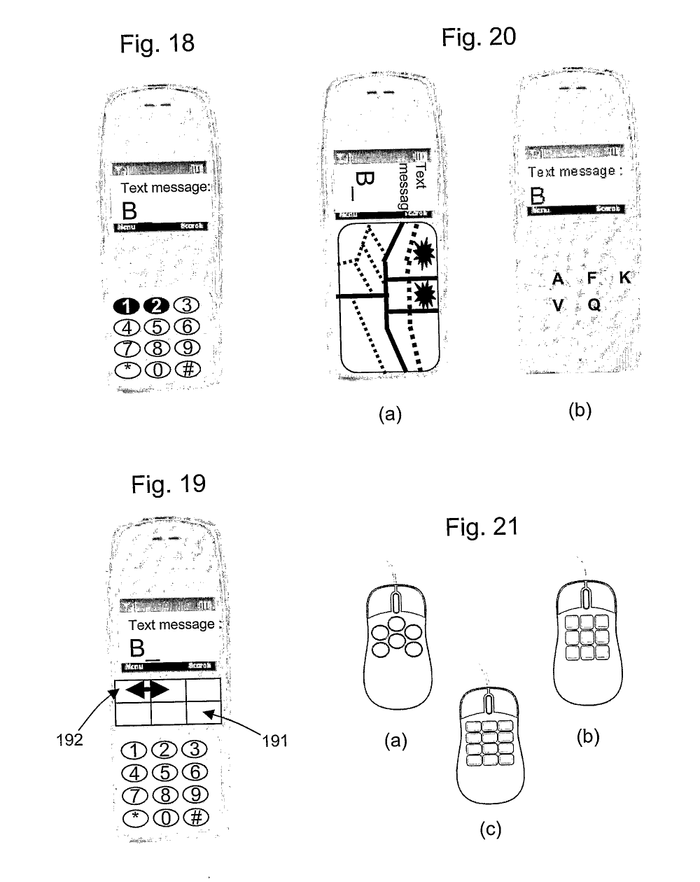

FIGS. 18, 19 and 20 illustrate different implementations of the DEMD on mobile telephones,

FIG. 21 illustrates the implementation of a DEMD as a set of 6, 9 or 12 keys added on the back of a mouse otherwise having a conventional number of contacts (left and right click, wheel, under the thumb, etc.),

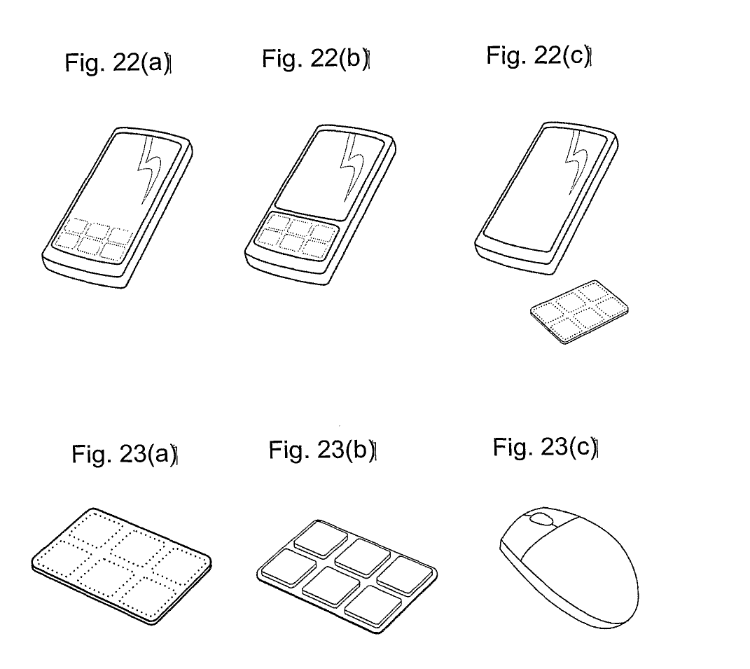

FIGS. 22(a) to 22(c) illustrate different implementations of the DEMD towards a display screen,

FIGS. 23(a) to 23(c) illustrate different examples of sensible zones for a DEMD,

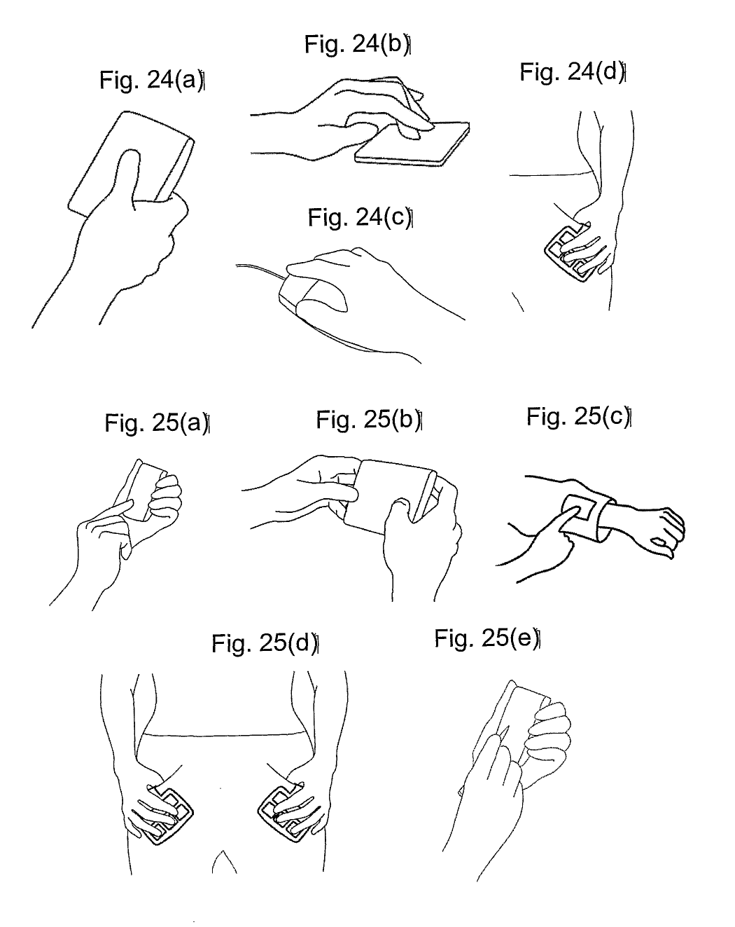

FIGS. 24(a) to 24(d) illustrate different implementations of the DEMD for an use with one hand,

FIGS. 25(a) to 25(e) illustrate different implementations of the DEMD for an use with two hands,

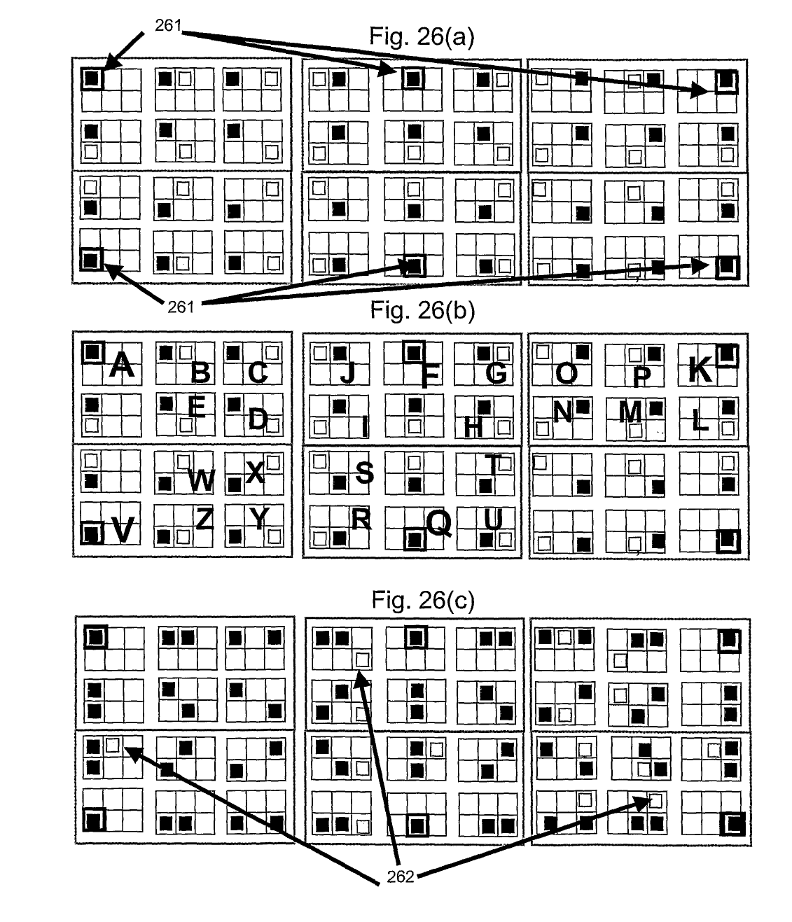

FIGS. 26(a), 26(b) and 26(c) represent how a cluster of N*N objects can be displayed in N visual zones and show how each object can be produced by actuating two or three sensitive zones, in different manners, successive and simultaneous,

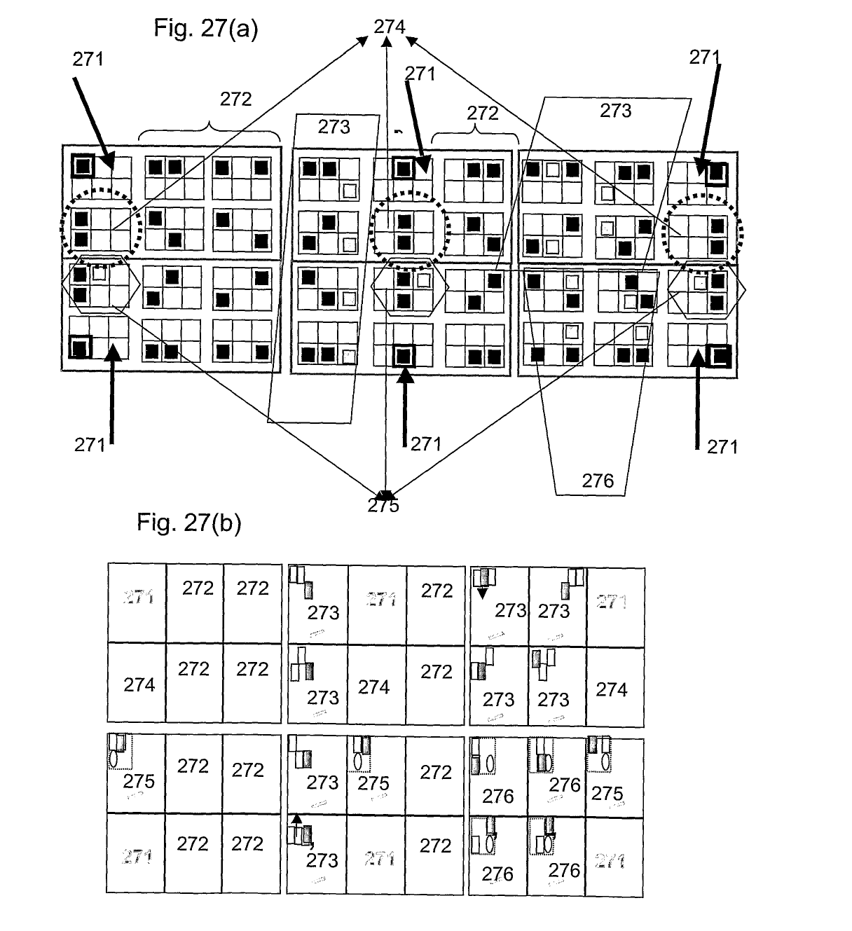

FIGS. 27(a) and 27(b), illustrate the 6 different categories of combinations, depending on the number of zones and the difficulty to activate them simultaneously, and

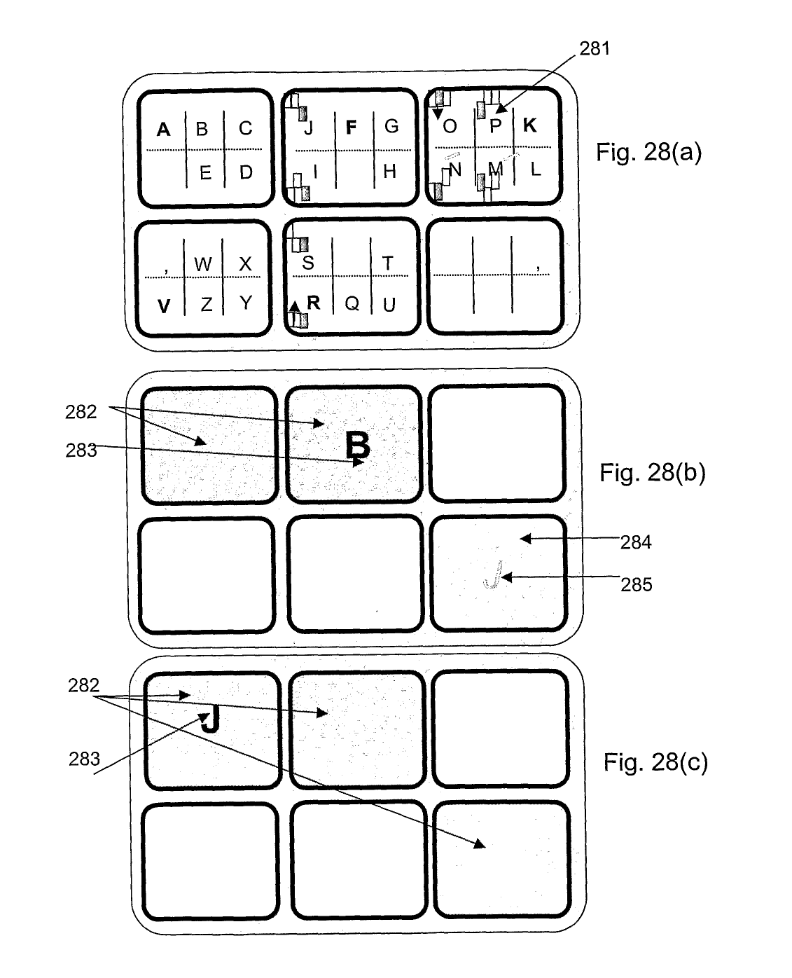

FIGS. 28(a) to 28(c) illustrate how the invention guides the selection of the third zone, before, while and after a first simultaneous activation of two zones.

### IMPLEMENTATION 1

FIGS. 1, 7(a), 10(a), 10(f) and 11(a) show an embodiment of the present invention according to which N=6 and the visual and sensitive zones are merged on a standard phone touchscreen. Each zone like 111, in FIG. 11(a) is arranged to be large enough to be both able to display 6 objects like letters and signs or icons and to provide an area bigger that a typical thumb tip. A helper zone (112a) is displayed above the 6 main sensitive zones and there are also 4 additional sensitive zones (113) under the 6 main sensitive zones. Globally all these visual-sensitive zones do not take more than half of the screen area. Globally, user can interact with this implementation of the invention either with the index finger (spontaneous posture) or a stylus, one thumb and two thumbs. See the illustrations 24 to 25. They can also glide from first sensitive zone to the second sensitive zone and change their mind before releasing and producing the selected object.

The posture with the hand above the 6+4 visual and sensitive zones is possible, but only when people no longer need to look at the visual zones. It would help, to know when a sensitive zone is activated, to implement touch screen haptic feedback or to have audio feedback, for instance in a Bluetooth earphone, or, even better, a tactile feedback via an electronic wristband or a watch with vibrations.

That very implementation can also work with an outside accessory (FIG. 22(c). providing either just the 6+4 sensitive zones with the invention software in the mobile, or a full multitouch touchscreen and the software in the accessory. With that variant, the accessory can interact with apparatus accepting a standard keyboard, either USB or Bluetooth, but the interaction is limited to what is in the accessory, letters, signs, numbers, commands, and also macros, predefined phrases, emoticons, and, why not, a completion and correction software. The accessory becomes an autonomous tool, and can work with various apparatus, phones, laptops, desktops, or any for which an external keyboard is possible. Of course, when the invention software can be installed, the accessory can switch to mere sensitive zones feeding the software in the apparatus and the user looking to the visual zones on it.

The accessory could also be a simple pointer (FIG. 23(c)) interacting at a distance with the visual zones on the apparatus which would not need a touchscreen. The pointer could be a touch surface on the apparatus (FIG. 22(b)) and that touch surface could be separated (FIG. 22(c)) for remote interaction then reinstalled in the apparatus block (FIG. 22(b)) to simplify handling and storing, just as everyone do with a stylus.

It is understood that this embodiment is not limiting and that an implementation in which the number of visual-sensitive zones is different is also conceivable in the context of the present invention (FIGS. 9(a) N=7, 9(c) N=8 and 9(b) N=9).

Variety of Actuators

The use of the fingers as principal actuators of the sensitive zones of the DEMD according to the invention is the most obvious solution. However any type of actuator could be used and even mixed together to designate different sensitive zones: stylus, pen, ends of limbs, mobile body parts, including devices for tracking eyes and eyelids (for the handicapped), head, fingers, from one to three in the context of the first embodiment, electronic pointer of any kind, etc. In what follows, different terms designating an actuator are used without that in itself restricting the description of the present invention.

It simply has to be recalled that according to the number of available actuators and the sensitive zones technology, the mode of designation could be successive, sliding, simultaneous or mixed, therefore slower or faster, and requiring more or less attention, but always making it possible to select a given object in the active cluster displayed on the screen.

Precision on the Word “Combination”

In every case, and in particular for the embodiment from FIGS. 1,2,3 and 11, the word combination must be understood broadly and include either Arrangements (considering the order of selection), or Combinations in the mathematical sense (not considering the order of selection), or a “mixed” combination of the two. This enlargement of the conventional concept of “chording keyboards,” until now nearly exclusively combinatorial in the mathematical sense, has the objective of making possible the use of a single given device, like that from embodiment 1, with a number of fingers or actuators or handled by them, variable from one to five, to take into consideration the different contexts where the user finds himself and his preferences. For that, the invention rests on a single canonical display, in accordance with the features of the human hand with up to five fingers, in tables of clusters common to all contexts, which contain “objects” which are designated and then produced according to a process for “writing” its “address” (first sensitive zone plus second sensitive zone) in the displayed cluster, which is adapted to the context, technologies with which the DEMD is implemented, number of movable actuators, and to the user's preferences. To consider the constraints examined below, a small number of objects in a given cluster might not be as easily accessible for all the processes or hardware technologies and their contents might possibly be duplicated in some other clusters.

Process According to the Successive Mode

One of the interests of the successive mode is it can be easily implemented to work with a single actuator, which is often practical, in particular for the DEMD according to the invention which will be implemented on mobile objects preferentially handled by a single hand (telephone, multimedia players, etc.) or when the other hand is occupied or when there is no support to hold the DEMD or when it is made in a technology which does not allow simultaneous pressing (current touch screens), as described below in the paragraph “technologies”. The successive mode with a single actuator also allows action with a stylus, or a pointing device, acting remotely on visual zones.

The base variant of the successive mode is the “Bitap” process already described above.

A first successive variant, particularly interesting because it is fairly natural and applicable with a large variety of actuators consists of gliding the actuator on a touch pad or touch screen type surface. In this variant of the successive mode called “Glide” a single actuator descends on the zone and then glides towards another zone while potentially passing by one or two others and then is raised, which validates the production of the designated object. (FIGS. 11(h) to 11(k)) The glide mode can be used with a stylus or a finger on a touch screen, but also with a pointer on the visual zones, which for that actuator become also, in fact, the sensitive zones. A pointer can be a mouse, a trackball, a video camera, or a touchpad (company's name) and many other existing solutions.

A pointer can also be an automatic cursor jumping from one visual zone to the adjacent one and circling, preferably following the same oriented line as for the disposition of objects in a visual zone, the user needing only to activate the only one existing contact when the good visual zone is put in exergue. In our industrialized world, regularly, some people are wounded up to be completely nearly immobilized in a bed for several days or weeks, recovering slowly the mobility of their limbs, hands and fingers. With the current invention they can start to interact with an apparatus as soon as they can act on a contact, but, moreover, as they recover they can increase the number and the mobility of the actuators they can use to increase their speed of operation, using the same logical system, until they have really recovered their two hands and arms to use a standard computer, its keyboard and mouse. It could make a big difference to use the invention instead of waiting to have recovered one's two hands.

In the gliding mode, the object selected is naturally tied to the first and last zones glided, but, it could also be tied to all the zones described by the slide, although it will be a bit complicated for a visual presentation on a screen.

When this “Gliding” is done with a stylus, the process approaches a cursive writing. Farther on, it will be seen that this cursive writing can be done without a sensitive zone, with paper and pen or pencil, or on a sensitive screen tablet, in a very small surface, for example the size of a large cursor, FIG. 16(c), which thus approaches manuscript writing recognition systems but with a simplified writing, because it is only simple moves from one zone to the other, and therefore it is easily produced and legible, either by humans or by electronic readers.

A second advantageous variant of the successive mode, called “Successitap”, consists, when the user can mobilize two fingers, for example both thumbs, and when the sensitive zones can accept it, to relieve the user of the need and attention to raise the first finger before activating, with a second finger, the second zone, if it is different from the first, and then raising both fingers together which represents a simultaneous validation analogous to that of the simultaneous mode. Some users will find it more comfortable and maybe, faster, if sensitive zones can react quickly enough, which is not the case on cheap touch screens. This second variant, which leaves to the user the choice of using one or two fingers, or three, thus realizes a first example of mixed mode. The six objects, also called “pivots”, which are produced by two successive press-raises on the same sensitive zone, remain validated with this manner, or by pressing it some time (Tempo7 or T7).

A third successive and “Successitap” variant favors the use of three nimble fingers positioned above the DEMD, each taking care of two sensitive zones, front and rear on a column, the hand remaining still. This variant, by removing the movements of one or both fingers between the columns of the DEMD, and allowing the parallel action of the fingers, improves greatly the potential speed. The slight problem involves the six objects produced by the activation of only one same zone, which requires nearly unnecessarily two successive presses or a longer pressing above T7. If it is desirable to make only one press for the 6 pivots, then the other 6 objects normally produced by the same one finger going successively from one of its two zones to the other are no longer feasible. When the technology allows it, a solution consists of allowing a single finger to activate its two successive sensitive zones on the same column successively but without being raised. This can be done with touchpad or touch screens type technologies, by a glide, or with keys working by a rocking/sliding of the finger. In practice this problem is more important when mixing simultaneous activation with Successitap is desired, because, in successive, making two successive press-releases on a single zone is not very penalizing. Another manner, which favors speed, consists of allowing simultaneous pressing with one finger on two sensitive zones. To reclaim the three objects using the same pair of sensitive zones in the reverse order, then the addition of a third key makes it, FIG. 26(c), although some users may find them awkward to do. Moreover these solutions are only possible with certain technologies, either conventional keys with low depressing force and suitably shaped, inclined and spaced surfaces, or touchpad or touch screen zones allowing multi-touch, which is still not frequent. Although the ambiguities and risks of errors are still low, it is advantageous to accentuate the differentiation between Successitap and simultaneous combinations by the definition of a time delay threshold T1 (tempo1) which delimits the Simultaneous designation (unordered and therefore short) from the Successive designation (in a given order, and therefore a little slower). A typical value for an average skill at pressing the fingers simultaneously is 30 ms for T1=tempo1.

FIGS. 11(a) to 11(g) show a method to input two different characters with a Bitap combinatorial mode according to the invention. The sensitive and visual zone that is considered is the first zone (111) shown in FIG. 11(a) containing the letters “a” to “e” and also shown in FIG. 10(a).

All these 5 characters are first displayed in the up left visual zone (FIG. 11(a)). In the case the user wants to produce the letter “b”, he actuates first the sensible zone associated to the visual zone containing the letters “a” to “e”. This first actuation leads to a second display of the visual zone, according to FIG. 11(b), where the activated zone (114) is put in exergue with light gray.

In this new display, each visual zone contains only one letter that is one of the letters contained in the first activated visual zone, so that their resulting relative positioning is the same as their relative positioning in the initially displayed visual zone before the first actuation.

The user points now the second zone (115) containing the letter “b” in order to actuate this, as shown in FIG. 11(c). The second actuation, which is put in exergue by dark greying the second visual zone and putting in bold white the selected object “b” (115). When user releases this zone, it makes the letter “b be inputted (116).

Then, referring now to FIG. 11(d), the letter “b” (116) is displayed on the application part of the screen and the visual zones are displayed as when no actuation has been made, like in FIG. 11(a).

In the case the user wants now to produce the letter “a”, which is a pivot letter in this cluster, he actuates first the sensible zone associated to the visual zone containing the letters “a” to “e”, as shown in FIG. 11(a). Then a second display appears (FIG. 11(e)), where the activated visual zone is put in exergue with light grey (114) and each visual zone contains only one letter that is one of the letters contained in the first activated visual zone, according to their relative positions in the first activated visual zone.

The user points now again the first zone containing the letter “a” in order to actuate this, as shown in FIG. 11(f). The second actuation, now puts the first zone in exergue with dark grey and the selected object “a” in bold white (117), and the releasing of this zone makes the letter “a” to be inputted. The letter “a” is then displayed on the display screen (FIG. 11(g, 118)) and the visual zones are displayed in the same manner as when no actuation has been made, like in FIG. 11(a).

In another embodiment of the invention, the first and second actuations for inputting the pivot objects may be obtained directly by maintaining the actuated zone at least during a preset time that allows to consider that these two actuations have been made successively. Then the releasing of this actuated zone makes the object be inputted.

FIGS. 10(a) to 10(e) resume the method for inputting these two letters “B” then “A”. Referring to FIG. 10(a) then 10(b), the letter “B” is obtained by actuating the first zone (which is light greyed 101) then the second zone (which is dark greyed, FIG. 10(c) 102) and puts the selected “B” in bold white (103). Referring to FIG. 10(a) then 10(d), the letter “A”, which is a “pivot” is obtained by actuating twice (or one time but during a long time or gliding slightly inside the zone) the same sensible zone. The first action light greys the visual zone (FIG. 10(d) 101) and the second action (2^{nd} tap, time-out or small glide) dark greys it (FIG. 10(e) 102) and puts the selected “A” in bold white (103).

The way to obtain each object can also be represented in such a manner (FIG. 26(a) or 26(b)) to show a cluster containing all the dominoes illustrating the 36 possibilities to input an object.

The variant with the gliding method a stylus and no zoom effect, for users knowing the process, will just ask to the user, after activationg the first zone (FIGS. 11(h) and 119), to move the actuator slightly (¼ of zone length) (FIGS. 11(i) and 120, which will put the zone in dark grey and the selected object “a” in bold white (120). Note that in the no zoom variant the N objects are not dispatched in the N visual zones, they remain in the first activated zone, which allows the user to see all N objects and the one selected to be put in exergue in bold white. If the user would release the actuator, then the “a” would be produced. Here in FIG. 11(j) the user glides to the right zone which is now put into exergue (dark grey, 122), with the selected object “c” in bold white in the first actuated zone (121). When the user releases the second zone, a “C” (because it is the first letter of a new phrase) is displayed on the display (123) and the visual zones go back to initial status (FIG. 11(k)=FIG. 11(a).

The gliding variant with no zoom effect and a stylus (104), is also illustrated from FIGS. 10(f) to 10(h). A first activation light greys the visual zone (FIG. 10(g) 101) and, FIG. 10(h), after the stylus travel (105) the second activated zone is in dark grey (102) and the selected object “D” is put in exergue (103) in the first visual zone (101).

FIG. 26(a) represents how a given object can be produced according to the different sensitive zones activated in the successive mode. This mode offers 36 combinations, all of which can be activated by the Bitap successive mode. The sensitive zones that are colored in black represent the first activated zones and the sensitive zones that are colored in grey represent the second activated zones consecutively to the first actuation. It can be seen that there are 6 pivot zones (261), which are the zones which produce an object by being both the first and the second actuated zone. This grid-cluster of 36 bitap combinations is also applicable in the “Glide” successive mode and on the “Successitap” successive mode.

Each object could then, for a given cluster, be superimposed on the corresponding domino (FIG. 26(b). That symbolic representation would have been rather overloaded and has been found less easy for beginners than the symbolic representation of FIG. 7(a) and the sequences 11(a) to 11(d), for the 30 standard combinations built with two different sensible zones and 11(e) to 11(g) for “pivot” combinations built with two actions on the same zone.

Process Based on Simultaneous Mode

The designation and validation mode which is the quickest but requires the most actuators is the one which can be called “Simultaneous”. This mode is used when the user knows the combinations of successive actuation enough, becomes an expert and therefore wants to increase his input speed. The user puts his hand above the sensitive zones (FIGS. 24(b), 24(d), 25(d)).

In this mode, the order of designation of the sensitive zones is not considered and the validation is done upon noting that the main zones managed by the three nimble fingers are physically deactivated and only considering the zones which were still activated at the time of validation less a certain time delay T2 (tempo2). This rear time delay scheme is necessary to take into account that raising the fingers is not absolutely simultaneous and to avoid that any zone which was activated and then deactivated since the previous validation could be taken into account, as is seen on most chording keyboards (like CyKey). At each raising off a physical zone, the T2=tempo2 is triggered for that physical zone, and at its expiration the associated logical zone is in turn deactivated. This tempo2 works as a clearing time delay for zones activated and then deactivated, for example during an exploration or trial and error. It cannot be reduced to zero because in this case some zones really wanted by the user would be seen as not making up part of the combination designating the validated object. A typical value for an average skill at raising the fingers simultaneously is 50 ms for tempo2. Also it cannot be too large because the clearing would be too slow, which would impede exploration and correction, important functionalities for the interactive guidance, described later. Not considering the order of activation of the zones makes the action of the fingers easier, in particular the transitions between combinations but only allows 26 useful combinations on six zones (3*3*3−1) and requires three fingers for eight of them. When the event triggering the validation of the activated combination arrives (for example no more physical zones activated), the object produced is the one corresponding to the combination whose logical zones are still active, meaning those whose clearing time delay tempo2 is not yet expired.

A manner of not having to add a third finger and to do simultaneous with sufficient combinations is possible when entering text with significant words in a given language. The principle is called disambiguation and was made famous by the T9 technique from Tegic. It consists of not asking the user to produce exact letters but being satisfied to produce a code associated with two (Suretype) or three/four (T9 or iTap) or six letters (Tengo) and let the software and its vocabulary tables remove the ambiguities by suggesting syllables or words that the user only needs to choose instead of typing them, which is not always advantageous with the existing selection systems. In the case of the invention, if two keys are tapped simultaneously, each of the 15 possible combinations can only correspond to two distinct arrangements by the typing order of the two single keys, which is a low ambiguity, easy to deal with state of the art linguistic programs. Only one root or a single word will very often be the only possibility. In the case of several choices, the fact that with the chording keyboards one does not look at the keyboard, makes it possible to only look at the screen, and therefore to see immediately the system messages, in the visual zones and then, with a dynamic guiding system associated with the interactive presentation (described below, FIG. 17), to present the choices in a manner to select them with a combination linked to the position of the choice in the dynamic guiding, therefore, without having to go activate any outside additional confirmation keys: one sees and clicks, producing the implicit combination which is then faster than finishing typing the word. Therefore when disambiguation software is available for the language in which a text is being created, one can have a simultaneous press by two fingers only, very easy and therefore rapid, and natural for user having started in “Bitap” and then “Successitap”.

FIG. 26(c) represents how a given object can be produced according to the different sensitive zones activated in the simultaneous mode. This expert mode accelerates the production of objects relative to the successive mode by taking into account the simultaneous press of a third zone to provide the disambiguation needed.

The sensitive zones that are colored in black represent the two simultaneously activated zones and the sensitive zones that are colored in grey represent the eventual disambiguation zones, activated when needed. It can also be seen that there are still 6 pivot zones (twice the same zone).

Advanced Processes

In an “Advanced” process for adept users, the designation mode combines the Simultaneous and Successive combinations. As above, the definition of a time delay threshold (tempo1) makes it possible to delimit the Simultaneous designation (unordered and therefore short) from the Successive designation (according to an order, therefore a little slower). The advanced process keep the N*N objects and combines several ways to produce them, either by Bitap, Glide, Successitap and Simultaneous modes, as explained below.

Specific Validations

In general, in the invention described here, a combination is validated upon raising, either the last finger (Bitap or Glide modes) or the different fingers making up the combination (Successitap and Simultaneous). So long as a nimble finger is activating a sensible zone, there is no validation, which makes it possible to correct a combination before producing it erroneously and with the clearing time delay T2, and screen presentation or with other means, as described below, exploring the contents of the active clusters and tables (thereby emulating the search on a conventional or virtual keyboard and making it possible for the beginner and the expert to find an object that they have not yet, consciously or reflexively, fully memorized).

For the beginner, this process can be too sophisticated for their skill level. According to the state-of-the-art, for certain confirmations of important objects, such as standard phrases presented by icons, it can be anticipated, in the relevant case, that the confirmation will not be done on raising, but after this raising, which brings up a confirmation window according to the state-of-the-art, and will be confirmed by responding “yes” or canceled by responding “no”. In the case of “no”, the DEMD returns to the prior state; in the case of “yes”, the DEMD goes to the normal state after a validation.

In an “individual” mode, some positions in a cluster could be validated upon raising only the second or third finger of the associated combination, which would make repetitions easier, according to a familiar movement, for example for increasing or decreasing the volume, or turning pages. In this case, the immediate exploration described below will be lost for these objects (it will remain valid by leaving the final finger of the combination raised beyond the time delay (tempo2) for clearing/exploration).

This individual mode corresponds to a general need for repetition of the combination. To avoid having to repeat the full combination or to make possible faster repetitions than the fingers could do, there are several possibilities for obtaining repetition, for a combination or a sequence of combinations, without losing the important capacity for exploration and correction before validation. Example 1: by a triggering on holding pressed similar to classic keyboards but only following the second successive designation of the same combination. Example 2: by the creation of an internal software function which would be placed in one particularly practical or logical position and whose designation and holding pressed would trigger the rapid repetition of the preceding combination (or of a succession like Alt+Tab, Ctrl+--> or Ctrl+Del); this repetition would stop on raising and restart on repressing that dedicated combination.

Comparison of Clusters Capacities

Although this is not an obligation for the users, the invention allows the user's personal tables to be logically the same for the different designation and validation processes. This supposes, in each cluster, for each process mode, an equal number of positions addressable by arrangements or combinations or a mix of them.

For six sensitive zones and three nimble fingers, the bitap and successive mode give access to 36 combinations (arrangements) and the simultaneous mode 26 true combinations. When these 36 arrangements and 26 combinations are brought together, and represented with dominoes (FIGS. 26(a) and 26(c)), it appears that the 36 arrangements are distributed between 12 arrangements made with one finger and 24 with two different fingers and that the 26 combinations includes six made with one finger, 12 made with two fingers and eight made with three fingers.

As shown on the FIG. 26(c), if the user wants it and the sensitive zone technology allows it, the 36 arrangements can become 36 combinations by pressing simultaneously the two sensitive zones of the “bi-tap” process, and adding a third sensitive zone to fifteen (15) of them. That third zone can be pressed either after the two original zones, as a beginner will do, or directly simultaneously as an expert will do most of the time. The big advantages of the present invention is that all options will be symbolically shown in the interactive display (FIGS. 28(a) to 28(c)) and will allow exploration and correction. First, when the user chooses that parameterizing, the third zone will be shown on the display, both before any action (FIG. 28(a), 281) where you see additional symbolic information about the third zone of corresponding combinations, and after pressing simultaneously the two original zones which are shared by a pair of two Arrangements (FIG. 28(b). There you see that the two zones simultaneously pressed are black greyed (282) and the “B” is put in exergue (283). If the user releases the two zones simultaneously, a “B” will be inputted. But you also see that a third zone is light greyed (284) and a “J” (285) is shown to say that you just have to add that third zone to get a “J”, because you pressed the two black greyed zones too quickly (below T1 time out). When the user presses the third zone the displays becomes what is shown in FIG. 26(c), where all three zones are black greyed (282) and the “J” is put in exergue (283), ready to be produced at simultaneous release. If he releases the third zone, after the T2 time-out, the display comes back to FIG. 28(b) and a “B” will be produced if he releases the two remaining zones inside T2. This learning and training mechanism will render the upgrade training from the “bi-tap” process to the quick chord process easy for everybody, each at his own progressive and reversible pace.

On FIG. 27(a) are illustrated the 6 combinations categories into which the 36 arrangements and pure combinations will be distributed according to the way they are produced and the difficulty to produce them simultaneously:
6 pivots combinations, (271) which can be parameterized to be produced by only one tap if the user uses at least two actuators to produce all 30 others, (T0 time out is no longer useful),
12 combinations (272) which can be produced by pressing and releasing simultaneously only two zones, with two different fingers or actuators,
8 combinations (273) which are produced by adding rather easily a third zone,
3 combinations (274) which can be produced by pressing two zones in the same column with one finger only, if the technology allows their simultaneous press,
3 combinations (275) which are produced by adding a third zone pressed by another finger or actuator to the two zones pressed by the same finger, when the technology allows it,
4 combinations (276) which are produced by adding a third zone but with only two fingers actuators, which is more difficult to train and do, and need a complying technology. These four combinations may remain done successively for a long time and the clusters objects population should take that into account,
Any time, the user can use the “Bitap” process and tap the two sensible zones for a given combination, in a time bigger than the T1 time out, for all combinations,

FIG. 27(b) indicate the number (271 to 276) in each combination position in a cluster.

That heuristic way to create upward compatibility between the “bi-tap” and the simultaneous chording process is typical of the current invention and can be applied to all N*N variants. Note that the added third zone has some mnemotechnic characteristics, and that it can be added after the two “Bitap” has been pressed or pressed simultaneously with them, which makes a nearly unique whole organisation and distribution, not counting all symmetric variants.

Nature of the Objects

The present invention is not limited to alphanumeric character type computer objects because it allows, for example, assigning a function of the apparatus to be controlled, such as for example opening an application on a computer or turning off the TV set, to a particular action of fingers on a particular set of sensitive zones.

Generally, a designated and confirmed object can be, without restriction: one or several alphanumeric characters, a standard phrase, an image, a computer icon, an item from a scrolling menu, an internal command for the operation of the DEMD itself, or guiding external equipment, an internal program on the apparatus, or an external program residing on third-party computer or electronic equipment, on any macro instruction concatenating several objects in a given sequence.

The interest of being able to designate any type of object lies in the possibility of controlling with the fingers of the nearly immobile hand everything which can be controlled on an equipment without using a dedicated device (keyboard and keyboard commands, and mouse for everything which is computer related, remote control for electronic equipment, etc.)

For that to be operational, it is clearly necessary to separate in the object, according to the state of the computer art, its symbolic representation (letter or word or icon), its executable content, its means of transmission and execution in a certain context and at least one possible explanatory label, (to be displayed in the helper zone), analogous to what can be displayed when one passes over a scrolling menu item or an icon from a graphical HMI.

The table of clusters containing the objects with their different components are naturally, according to the state-of-the-art, files, notably at the level of execution elements, which are exchangeable and adaptable to different contexts and apparatus and devices which the user would like to use and control with the same visible elements from the personal tables.

All this, according to the state-of-the-art, would rely on table editors capable of collecting or entering the objects to be placed in the tables and adapting the elements to them.

Construction of Tables/Clusters

The clusters can contain objects of heterogeneous nature examples of which were previously provided. In some contexts, in particular in the computer domain, it will be advantageous to have a device or software making it possible to record all the available computer objects (icons, commands, applications, etc.) and organize them in the forms of clusters and tables in order that they can be presented, designated and activated by the device from the present invention, much more quickly than an electronic pointer, much more compact than a conventional keyboard much more powerful than the current solutions implemented in the current small portable or personal electronic apparatus.

The representation of these objects can be the object itself (which is in particular the case for the alphanumeric characters) or an icon representing the object (an example is the icon from the Word toolbar allowing the execution of a specific command).

Technologies

The “mouse” solutions are not suitable for a large part of the mobility apparatus and contexts. In these cases, various technologies exist for implementing different detection zones and a pointer when there isn't a surface for operating a mouse. Among others, note the technologies associated with capacitive or resistive sensors, of the Touchpad type (company's name), which can be “multitouch”, and make it possible on a single surface to create, for this implementation 1, both six (6) independent sensible zones for simultaneous action and, by software, the management of a pointer. The present invention can then provide a small device or and independent accessory which cumulates, under one hand or even one thumb both a powerful keyboard and a pointer. Of course, if user chooses that smart option, he will loses the gliding designation option or will have to give a command to switch between keyboard and pointer functionalities. and, when it glides, manage what is a mouse equivalent on the same sensible surface.

An advantage of the capacitive touch solutions resides in the thinness of the sensors allowing for their integration in systems such as portable phones (FIGS. 20 and 22(b)). Resistive technologies make it possible to implement equivalent sensitive zones, where the differences mainly bear on the force necessary to activate the sensitive zones: non-null in resistive technology, which slows the designation and confirmation of objects, and null with capacitive technology, which could give rise to involuntary activations.

Many detection technologies can be considered in the scope of this invention: either the detection is done on and by the surface where the fingers are positioned and move, like capacitive or resistive touchpads, conventional keys, or on membranes, or on surfaces where a smart sensor and program detect locations via the impact sound travel, or else the detection is done by sensors not integrated in the surface where fingers stop and rebound, and the surface might even not be necessary, such as light or radio detection, or via a mix of different direct and indirect sensors of the angle of the phalanges integrated for example in electronic gloves. (U.S. Pat. No. 5,194,862 filed in 1993 by Philips, or fiber optic technologies extending along each finger) or detectors of moving wrist tendons. These latter beams or phalanges or wrist tendons sensors could advantageously be put to use by wearing the core of the finger-position detection-device in a bracelet at the wrist of the hand involved.

The present invention also applies when the sensitive zones are created on the touch screen and merged with the visual zones (FIG. 22(a), according to the state-of-the-art. Generally, these touch screens are not currently manufactured to accept a multiple press, (“multi-touch”) although that is entirely possible like in the implementation with the touchpad technologies described above. In this case one can use, in successive or glide mode, only one actuator, either finger or thumb, on surfaces analogous to those of a virtual keyboard (for example a keyboard shown on a touch screen), or a stylus on surfaces of the size of a large cursor (FIG. 16(c)). FIG. 16(c) illustrates an implementation example of the invention. In text processing software, an intelligent cursor shows a grid (161) representing the very small virtual keyboard and in which the different zones to be activated are designated by the stylus to produce the desired object, and the helper zone is superimposed to guide the user before releasing the stylus (FIG. 16(c), 163 showing a “W”, as in FIG. 16(b)) in the making while the stylus is reaching second zone (162).

The present invention also applies when the detection zone is virtual, for example when the logical zones are simulated by a computer for interacting with an electronic pointer, mouse type, (FIG. 23(c), which is then the single actuator handled, in successive or slide mode, by the user's hand, which can be away from the screen without any other device than the current equipment of a standard computer and just the invention software to be installed for emulating the system's keyboard. In practice, this virtual implementation will be advantageously combined with the implementations of sensitive zones placed under the fingers (FIGS. 23(a) and 24(b)) in particular in a manner to ease the user's cognitive transition from the dominant graphic HMI with pointer towards the use of the additional HMI where the movements of the fingers are sufficient to designate and confirm a computer object, presented in the invention symbolic representation.

The pointer can be a camera reading the movements of fingers or of the full hand, with the interactive guide on the screen, soon with only the transparent grid, giving back all the screen area for the content (multimedia screen, distant big screens . . . ).

A significant feature of the invention is being able to be implemented in multiple ways according to the available hardware components, in particular by simple installation of ad hoc invention software and personal tables of the user.

Visual, Audio, Tactile and Kinesthetic Feedback

Whereas with the conventional keyboards, in particular in their implementations for mobile objects, the large majority of users look at which key to act on with their fingers which they guide with their eyes, the feedback being visual on the screen, the well-designed chording keyboards simplify the movements made by the fingers and the majority of users can make use of tactile feedback from the fingertips and kinesthetic feedback from the relative movements of the phalanges.

This tactile and kinesthetic capacity is particularly optimized with implementation 1. Since there are only two positions (FIGS. 4(a) and 4(b)) of the fingertips on the rebound surface, this give rise to distinct sensations in the fingertips which makes it possible for the user's brain to know, before raising the fingers, whether they are well positioned where they must be for designating a given combination. In fact, the fingertip is extremely sensitive and makes it possible to distinguish between two positions of the finger very close together such as illustrated by FIG. 4.

This information is reinforced by differentiated implementations, potentially with vibration generators, of the surfaces of the different sensitive zones assigned to a single finger, perhaps by creating a sensitive border like a small dip for zones separation, and by the kinesthetic sensation of the angles of the phalanges.

This good tactile feedback with implementation 1 makes it possible for the users to reach more quickly the reflex mode where the conscious mind is no longer called upon to control the fingers'movements, which frees the users'attention from entry actions and makes it possible to reach more quickly, after less time using it, the maximum speed allowed by the intrinsic tapping speed capacity of the fingers of the users'hands (maximum 15 taps (cycles) per second for a virtuoso pianist or flutist to three for a person much less agile with his fingers, average users being able to tap around 7-8 times per second).

These tactile and kinesthezic capacities of the human hand and mind are not reasons not to provide various other presentation means in additional echo to the fingers positions feelings, for example in the form of a range of active tactile zones corresponding with the sensitive zones of the DEMD or of an audio or visual echo according to the means for interactive guiding before validation of the combinations invoked above.

Possible Dimensions for the Implementation of 6 Sensitive Zones

The dimensions of the DEMD according to implementation 1 vary according to the actuators used.

When the DEMD is made to be activated by three fingers, the DEMD must have at a minimum the width of the central finger and half that of the two left and right fingers, slightly increased to allow fingers movements, which, depending on the person, makes a minimum total width of 30 mm.

In height, one of the important features of the invention is that, because of the fact that the two sensitive zones assigned to a given finger are not very often activated together, it can be sufficient that the main zone detects that the actuator is more front or more rear for distinguishing the two cases. Pressing/Activating two sensitive zones simultaneously with the same finger is equivalent to creating in fact a third zone between the two and further requires the precaution of avoiding bad presses relative to what is targeted and thus slows the action and increases the necessary areas, but that can be a preferable compromise in certain cases (very small apparatus) and with certain technologies. In all cases these simultaneous presses by a single finger of several zones must remain limited to a few cases (not more than 10), easy to do with the fingers. Thus in height, a DEMD according to the invention can get down to a few millimeters. The trade-off for a small height is that one can't go as fast as with bigger heights, for fear of being outside any sensible zone. But this can be a very interesting compromise in mobile and discrete situations.

These minimal dimensions are not an obligation because often the user will prefer to have a comfortable surface that can also serve as a pad for tracking movements associated with a pointer. 50 mm×25 mm, or half a credit card, (FIG. 25(c)), seem to be dimensions that can be agreeable to many users.

When the DEMD is used in successive mode by two finger actuators (such as two thumbs), or even only one, the dimensions can be reduced without the user having to look at his fingers.

In successive or gliding mode activated by only one stylus, the dimensions can get down to a few mm², but the user's attention is called on, as when you write on paper

In summary, the DEMD according to implementation 1 can be a very compact device all while being powerful (36 objects in a basic 6*6 cluster but able to go up to 8*8=64 or 9*9=81 possible combinations in a single cycle of action of the fingers). The size reduction therefore translates into a certain reduction of possible speeds but without going below the writing speed with the other known writing means on mobile objects, which ask for much bigger areas and more attention.

### IMPLEMENTATION 2

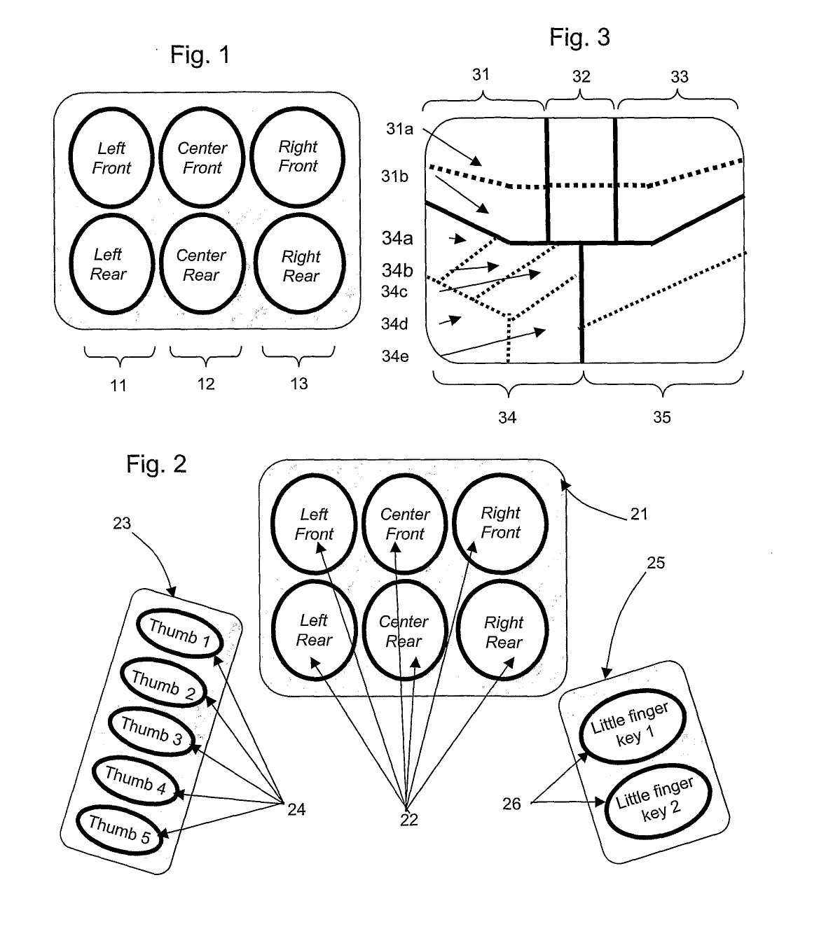

As illustrated by FIG. 2, another embodiment consists of defining thirteen sensitive zones in three distinct areas (21, 23 and 25): six zones identical to the embodiment 1 defined previously for the three nimble fingers, five sensitive zones (24) associated with the thumb and two sensitive zones (26) associated with the little finger.

The five sensitive zones for the thumb provide for six different states and the two for the little finger provide for three different states.

By logically building these additional sensitive zones as “modifying” keys (like Shift or Ctrl or Alt on conventional keyboards), this type of implementation considerably increases the number of possible combinations in a single action cycle of the 5 fingers, (36*(5+1)*(2+1)=648) exceeding the constraints discussed above during the description of implementation 1, which makes it possible to go towards “Simultaneous” processes, without order, therefore much more quickly and favoring reaching reflexive mode, an additional factor of quickness. The constraint is reported on the size, where the type 2 implementations are by nature larger than the type 1 implementations.

Possible Dimensions for Implementation 2

Relative to the implementation 1 whose main objective was the smallest size, the main objective of a type 2 implementation is to allow the effective and comfortable use of all five fingers to get more power, faster.

The minimum size is therefore that of a credit card, where the thumb and little finger are required to pull in a little under the hand. The next comfortable size is that of a calendar, for example 70 mm×110 mm. Objects for use on a table could reach the A5 form factor. The effective sizes and shapes of users hands, which are very different and varied between individuals, lead to the idea that there will exist a wide range of DEMD sizes.

A priori, the technologies are the same as for implementation 1, with a greater importance for the single or multiple “pointer” function.

In this case, the implementation will tend to make it so that the different sensitive zones for each finger are contiguous and together implement a sort of graphic tablet, as shown by FIG. 3. In this illustration, the solid lines indicate the limits of the 5 main zones (31 to 35) of each of the five fingers and the dotted lines, indicate the sensitive zones (3xa, 3xb, . . . , where x=1 to 5) of each finger within its own dedicated zone. The sensitive zones can be switched by software to provide left and right solutions with the same hardware (FIGS. 5, 56 and 55).

For a physical mouse enhanced with a type 2 implementation (FIGS. 21(b) and 21(c)), the fact that the thumb and little finger are used poses the problem of involuntarily moving the mouse during the entry operation. Several solutions can be implemented like, keys in the center of gravity, fairly flat shapes, antiskid pads, and software program for temporarily decoupling the screen pointer and has been found sufficient. One rather original solution is to put the DEMD and mouse buttols on top of a moving plate where the wrist rests, which enables the arm to fully control the plate movements and to put the mouse electronics under the plate. Then, the fingers will interact with the DEMD and the mouse buttons without much interference with the mouse, immobilized at will by the wrist-arm while the fingers of an immobile hand do their own job.

Alternatively, the pointing device can also advantageously no longer be a mouse but a touchpad or other solution where it's an actuator which moves and not the entire DEMD. These static implementations correspond to users more oriented to “keyboards” and “keyboard shortcuts” for whom the pointer is an additional tool and not the other way around for mouse oriented users (currently the large majority), and to uses where one cannot have a surface for moving the mouse.

Rotation or Substitution of Tables

Still in reference to FIG. 2 or 3, the sensitive zones associated with the thumb (24 or 34) and the little finger (26 or 35) make it possible, according to a conceptual design for arrangement of the available raw combinations and according to their combination, to switch the active cluster.

For us, the term “cluster” names the set of 36 (N*N) objects which can be designated by a combination of nimble fingers on the type 1 implementation presented above, for a given thumb and little finger positions.

The thumb and little finger zones are then in this case of Shift, Ctrl, Alt, AltGr, Fn, Win or Apple etc. keys type, meaning modifying keys, a universally used and well established concept for increasing the number of signs and commands that are possible with a set number of keys. The term table therefore brings together all the possible clusters according to the “thumb+little finger” combinations. In the implementation 2, there are six different clusters that can be designated according to the six possible states of the thumb on its own area (number of zones+1), which with the action of the little finger between its three states (number of zones+1), makes it possible to designate 18 different clusters by the simple positioning of the thumb or the little finger done within a base cycle for designation and validation of a combination.

In a particular implementation and configuration of the means for validation of the combinations, it is not necessary to deactivate the thumb or little finger zones for confirming a combination depending on the three nimble fingers. This makes it possible to limit the cases where all the four or five fingers must move in a single cycle, which is all the same still more difficult for everyone, but especially for the beginner, than moving only one, two or three nimble fingers. As was seen above and will be seen below for guiding, there is in the design according to the invention a clearing time delay T2 (tempo2) that clears a specific sensitive zone which was activated and deactivated before the validation could be calculated and acted. Then, the movement of the thumb or little finger, while at least one of the three nimble fingers activates a sensitive zone, translates, after the T2 time has been finished, into the simple change of the associated and displayed cluster, and therefore of the object which will be confirmed and activated by the deactivation of only the zones of the three nimble fingers.

Although the role of the zones assigned to the thumb and little finger are preferentially seen for reasons of mental reference by the user and for allowing the operation of the guiding tree as that of change of the active cluster and table, they can be also used for providing very frequently used objects for various clusters and tables, those particular objects being called only when only a single actuator is acting on one of the thumb or little finger zones. This defines a second role for the sensitive zones of the thumb and little finger. To make the production of these objects easier, like the space character, adding it to the object activated by the validation of the nimble fingers when the thumb or little finger zone is deactivated at the same time can be configured in the program. For example if the object activated is the last letter of a word, the space is automatically added just by lifting the thumb simultaneously with the validation of this last letter of a word, where the thumb had previously been placed on the zone calling a cluster of lowercase or uppercase letters and associated with a position where the space was located.

This mode of action for the rotation/substitution of a cluster or a table of clusters for another is supplemented by the fact that, according to the invention, it is anticipated that the commands for clusters or tables rotation can be also placed as objects in positions inside some clusters, calling small computer programs internal to the DEMD device. These objects internal to the DEMD for control of clusters or tables rotation are particularly useful when we are in a type 1 implementation situation with only 36 boxes available or accessible because of a reduced number of available actuators. According to the state-of-the-art, these tables or clusters rotations can be either temporary for the following combination only or locked until a different table rotation order ends the active role held by the called table or cluster.

In implementation 2, with five fingers areas, it is normally expected that the user will make use of all five fingers. It can happen that this is not possible or desired. In that case, they could configure their designation process, for example by an internal computer program arranged as an object in one position, so that the thumb and little finger sensitive zones, or even any other, can be locked out, meaning blocked, without there being a need for leaving a finger in the corresponding sensitive zone all while keeping the capacity for validating combinations to which they belong (similar to a “Caps Lock” function).

In another embodiment, rotation between two clusters or tables is done automatically by the detection of a new application context. For example, if the DEMD is being used for the entry of text in a text processing application, the switch to a spreadsheet application like Excel (company's name) could make it useful to add, in the same object, to the application switch, the change of cluster in order to have available a quick designation of functions and commands specific to these context and applications.

As for the interactive guiding display, when users have a big enough screen, it could be effective to display the whole table as a grid, where each cluster becomes a strip, and the guidance being provided by putting in exergue the smaller and smaller area of the grid which corresponds to the already actuated sensitive zones. No activated zone=the full grid, a thumb zone=the corresponding strip of a cluster, a nimble finger added, the strip area corresponding to the N objects sharing the same sensitive zone. All changing, after T2 time-out, when the fingers explore. Of course that solution is not to be used permanently but to quickly find a given object.

When several tables are used, a map of several tables could be displayed. As discussed later, when user maintains a zone actuated longer than a time delay T5, the display will go from one level to the upper one (more objects displayed) and will come back to the parameterized display level after the production of an object.

DEMD Pointing Devices

Considering FIG. 1 or FIG. 3, the use of certain technologies for the detection zones makes it possible to obtain a surface or continuous volume on or in which the continuous movement of an actuator can be determined.

In this case, the implementation will advantageously make it such that the five fingers areas together realize a sort of graphical tablet, as illustrated by FIG. 3. In this illustration, the solid lines indicate the limits of each five fingers zones (31 to 35) and the dotted lines, indicate the different sensitive zones (3xa, 3xb, . . . , where x=1 to 5) under the reach of each finger.

In an embodiment, the device therefore includes means making it possible to interpret the sliding of an actuator on the detection zones as the sliding of a computer mouse type electronic pointer. The means are of software type making it possible to interpret the coordinates transmitted by the sensor module to convert them into movement of a pointer in a computer system. This in particular makes it possible to move quickly without having to significantly move a hand from a data input device to an electronic pointer and vice versa.

Specifically, applicable in the case where the 5 finger areas are independent (“multi-touch” according to the jargon), for each finger area there corresponds a part of the screen on which a specific pointer device to each part of the screen is available. Otherwise, if so selected, any finger movement is a global pointer for the whole screen. This solution in particular makes it possible to move very quickly from one part of the screen to the other without having to make a global actuator glide from one end of the screen to the other or of managing, and coming and going between several independent cursors which make it possible to manage several separated tasks in one or more documents or windows. In the case of an audio presentation of the screen content, this absolute correspondence associated to the physically perceptible main zones by the five fingers of the hand makes possible a quick analysis of the content of a screen and of what moved where, without having to look or scan the whole screen, for example by audio or tactile presentation, according to known processes for blind people using a computer.

In a particular embodiment of the invention, all of the main zones form a single super zone dedicated to a standard one mouse one cursor usage, and can be switched on/off with the five distinct zones and cursors.

In another particular embodiment, the mouse function is implemented with joystick or touch pad type means juxtaposed to the device's sensitive detection zones.

In another particular embodiment, notably for use on a table or other surface, the DEMD is naturally installed on the upper part of a mouse, the ultra dominant pointing system, made according to the state-of-the-art. The simplest solution for implementing the subject matter of the invention is in fact to place the conventional keys on the top of a mouse according to the state-of-the-art and FIG. 21. FIG. 21a corresponds to the installation of a type 1 implementation, FIGS. 21b and 21c to the installation of type 2 implementations. The 21a implementation is naturally ambidextrous, the three fingers areas, left, middle and right, remain as they are whatever the fingers which use them. The implementations 21b and 21c are also ambidextrous, by means of a permutation of the zones assigned to the thumb and little finger.

To make the whole thing easy to handle it is necessary to make the mouse fairly flat, to make it so that the mouse click and wheel are oriented towards the interior of the surface, that the chording keys are substantially softer and more limited range of travel than for a standard keyboard, that the shape of the mouse seen from above allows it to be effectively held between the thumb and little finger and finally that the total mass and sliding pads of the mouse limit unintended movements of the mouse while acting above with the three fingers or even with the three fingers and thumb, FIG. 21b, or five fingers, FIG. 21c. High resolution optics (above 800 dpi) well adapted to mice with small movements is very suitable to an implementation according to the subject matter of the invention. Software programs inhibiting the possible movement of the pointer during typing make it possible, without asking anything from the user, to keep for the mouse all the ergonomics which is associated with it. To consider the small delays separating the last mouse/pointer use from the validation of a first sensitive zone of the DEMD, which inhibits the pointer, and between two successive productions of the DED, a time delay T6 (tempo6) makes it possible to clear and cancel the involuntary movement if there is any during this small interval.

A bigger solution is to use a plate moved by the wrist and the arm leaving all five fingers of a still hand independantly acting on various zones and keys or wheels.

Conduct of a Designation-Validation Process

FIG. 6 illustrates the process for producing an object according to the present invention.

By referring to the embodiment from FIG. 1, the user designates (interactive designation guided or not) (63) a combination of logical zones using one to three of their three nimble fingers. The user then performs a production operation (66) which inputs the object (67).

In the basic embodiment for which the DEMD is equipped with a presentation screen, for example, the creation process arises from the following sequence:

61: By thinking, the user determines what object he wants to produce.

62: The symbolic visual presentation (described below) of the information makes it possible for him to see how to designate this object.

63: Therefore he designates this object with or without guided interactive assistance, with the use of actuators (fingers).

64: The user verifies that he has in fact designated the desired object, and sometimes makes use of additional information (69, for example a small informative bubble or label (the helper zone 112x in FIG. 11 or 122 in FIG. 12(b)) displaying the functionality of the object when it is designated, like the information bubbles which are activated by computers when the mouse cursor is positioned over a Word button, (company's name) and which is shown to them to reinforce it. He has also tactile and kinesthezic feedback to inform his brain.

65: If the user is not OK with the current selection, he can change fingers position and explore (steps 62 and 63) or even quit.

66: The user validates his choice, for example by raising his fingers; the different means and modes of validation were described in more detail above.

67: The designated and validated object is thereby produced and inputted to the apparatus.

68: Feedback (for example, letter which is written on the visualization screen, or vocal or tactile echo) allows the user to check the result and to go to the next selection 61.

Symbolic Presentation

In the present invention, in the visual zones, the presentation of the information on the visualization screen (or any other presentation means) is of big importance to guide beginners or users who don't know or don't remember how to produce a given object.

Means, for example software, make it possible to symbolically display on the screen the active cluster and the means (meaning the sensitive zones that have to make up a given combination) to activate each of the objects contained in the active cluster.

In reference to FIG. 7(a), for an implementation type 1 arrangement, such as that from FIG. 1, the compact symbolic presentation consists of a grid of 6 visual zones each displaying 6 positions, which make 36 positions. This map is used before a first actuation and will change after between the first and the second actuations.

The arrangement of FIG. 7(a) contains all 26 latin alphabet characters among the 36 possible positions. The symbolic representations indicative of the characters are their well known and common used visual representations. Before the first actuation, they are all displayed in order to make the user have a global visibility of the relative positions of all the 26 characters.

The visual zones contain alphabetic characters that are positioned according to the well known preset alphabetic order (for people where this 26 letters alphabet is used). Each group of consecutive characters is put in a visual zone in such a manner that the characters are positioned on an oriented curved line, by following the alphabetic order of the objects.

The relative positioning of the symbolic representations in each visual zone is the same as the one of the visual zones on the display screen and, the sensitive zones.

Before the first actuation, in a given visual zone, symbolic representations are positioned according to a precise way that allows less effort for memorization and that is more intuitive for the user. Referring to FIG. 7(b), the objects (letter “A” to “E”) of the first visual zone are positioned on an oriented curved line. They are arranged in the corresponding visual zone in similar positions as the visual and sensitive zones, by following a pre-set order of the objects, that is the alphabetic order. Moreover, in this first visual zone, the “A” character is the one that may be selected by first and second actuations of the same sensible zone. According to the oriented curved line, the object from which the curved line starts is the “A” character, which is the one inside that visual zone which is the first character in the alphabetic order.

In a same manner, referring to FIG. 7(c), objects (letters “F” to “J”) are arranged according to an oriented curved line and according to the alphabetic order. The starting point from this curved line is now the “F” character, that is the first of the visual zone in the alphabetic order and that is the one that is selected by first and second actuations of the same sensible zone.

For the implementation type 1 arrangement from FIG. 1, another compact symbolic presentation may be different, as illustrated by FIG. 8(a). The presentation consists here of a map of 6 visual zones displaying 6 positions, but the visual zones are separated into two groups of three visual zones. Such an arrangement of the visual zones allows for the user to input easily data or object of such a cluster with the two thumbs of the hands holding the graphic or Internet or GPS navigation tablet.

In these two embodiments illustrated by FIGS. 7(a) and 8(a), it is to be understood that the visual zones are displayed on the display screen in the same relative positions and forms as the corresponding sensible zones. This positioning makes it possible for the user to input data or objects more intuitively because of the similarity of the arrangements of objects, visual zones and sensible zones and their permanent visibility in the idle state.

To guide the user among several tables or many clusters, the components can be represented, according to the state-of-the-art for graphical HMI and multi level tree structures, by icons illustrating groups of combinations (of other clusters for example instead of the set of the icons for each combination, where each icon, when it is designated can be explained by a text label in the helper zone (FIG. 11, 112x), according to the state-of-the-art.

Other representations are also possible, in particular that illustrated by FIG. 16(a), where the cursive shapes can be considered as being a production alphabet: a combination corresponds to each sign.

This manuscript writing which is initially a variant of the visual representation of the positions of the fingers on the sensitive zones, proves to have a great simplicity to produce in manuscript form, either in connected cursive manner (FIG. 16(a)), or slid or pointed in a pre-existing grid, (FIGS. 16(b) and 16(c)), and proves as very easy to recognize, both by humans and robots, because it is formed from simple elements, easy to distinguish by a simple writing recognition device. For example, an optical pencil with some diodes or equivalent, would easily detect the succession of upper and lower stems relative to the beginning and end of the central trace. Similarly, relative to a grid, physically represented or not, the vectors and the points are very easy to draw, and then, in real time or a posteriori, to detect, identify and connect to the models associated to the 36 base combinations. Adding, up to six upper and lower accents, (equivalent to 6 thumb positions in implementation 2 FIGS. 2 and 3), which would be simple to identify, also make it possible to define a base set of 6 different clusters providing up to 216 signs possibilities.

Similarly a graphics-tablet system or touch screen and recognition software can easily do this processing, whereas they have difficulty recognizing more than 95% of the signs of common or even simplified handwriting.

The advantage of this writing, which is quicker to draw and has a significantly higher recognition rate than not completely natural handwriting of conventional signs, is to extend the domain of usefulness for learning the current invention system in situations where it is advantageous to handle a stylus or pencil with or without real-time electronics, or for recognizably annotating printed documents before scanning. The simplification of the recognition makes it possible to do it with fewer resources, more in real time, to the point of writing, without a special zone, etc.

As brought up previously, the symbolic representation according to FIGS. 7(a), 8(a), 9(a) to 9(c), can advantageously be made equivalent to that of a virtual visual keyboards according to the state-of-the-art where the pointer clicking or gliding make it possible to successively designate at a distance, with or without sensitive material zones, and then validate the combinations according to the method subject of the invention.

It is the main objective of the invention to guide the user from the absolute beginner status and bitap mode to the absolute expert using quick simultaneous mode without any visual help and therefore getting back the full screen for contents.

Then, according to the user's degree of expertise, the nature, size, significance and permanence of the symbolic presentation will advantageously be adjustable. Several configurable levels can thereby be distinguished.
1. The permanent and dynamic level but limited to a cluster of 36 combinations according to the symbolic representation from illustration 10(a), with zoom on the six combinations remaining possible after a first press (FIGS. 10(b) and 10(c)).
2. The permanent level limited to a cluster or extended to a table of several clusters where the dynamic is limited to adding emphasis or putting in exergue the activated zones and objects which share these activated zones (FIGS. 10(g) and 10(h) or 11(h) to 11(k)).
3. A level, for example at the cursor point where only the sign or command ready to be confirmed is displayed in a water mark helper zone, and if needed changed according to the exploration before validation or cancellation, according to FIG. 16(c).
4. A level where the display has partially (the contents but not the transparent grid) or totally faded after a certain time delay T3 (tempo3), and does not come back to the foreground until a sensible zone is activated, which allows for the normal use of the mouse pointer on the screen zone which the guiding presentation would have occupied.
5. A level where a display of the current cluster or all the active clusters are kept in background and only reappears after the passage of a certain other keep-activated time delay (tempo4) for at least one sensitive zone, where this time delay is interpreted as an hesitation by the user, and where the display fades again after the validation of a combination.
6. A level where the display of how to do the possible commands in a given context, (by a symbolic image of the zones to be activated) is done dynamically, not in block specific to the DEMD according to the invention, but next to each icon or element of the scrolling menu in progress with the movement of the pointer or change of context (standard visual and graphical user interface or GUI).
7. A level for the different types above increased for the object designated and ready to be confirmed, by the display of an explanatory label analogous to that associated to an icon or item from a scrolling menu according to the state-of-the-art of graphic HMI, where this explanatory label can be reduced to a few words or make up a real paragraph of Help (Helper zone, FIG. 12(b)).

If the operating system allows it, the whole visual and sensitive area could become transparent (leaving visible just the grid and possibly the helper zone), which gives back the whole screen area, as shown in FIG. 13. The cluster appears as a transparent grid (131). This embodiment allows a speed increase of the input software since it has now less data to display on the display screen and therefore has more capacities for computing screen information flow and inputting objects faster.

In another embodiment, when the cluster is used with a stylus or not used for a moment, it may be displayed in a smaller grid (141), as shown in FIG. 14, in order to economize an important part of the display screen (which would be useful for other applications). This smaller grid (141) may become bigger as soon as the user needs the objects information display, for instance when he maintains his stylus pressed longer than the tempo4. That small grid can become a cursor inside the application, (FIG. 16(c)).

Referring to FIGS. 15(a) to 15(e), different types of cluster (and objects) may be implemented in the method and device according to the invention, as for example:
a cluster of alphabetic characters (FIG. 15(a)): the order is the alphabetic order,
a cluster of numeric characters and punctuation characters (FIG. 15(b)): the order for numeric character is the well known numeric order, the order for other characters is more arbitrary but keep some logical organisation, displayed permanently, to help memorization and quick action,
a cluster of special alphabetic or punctuation characters (FIG. 15(c)),
a cluster of computer commands (FIGS. 15(d) and 15(e)), allowing to launch a software or a special command.

Exploration—Learning

The combination of dynamic and static presentations previously described, and clearing process already described for the designation process, makes it possible for the novice or hesitant user (experts included) to explore the content of the various clusters and adjust their fingers so as to correctly make the desired combination while they still have not yet validated their combination.

This exploration and these adjustments are necessary for the non-expert use of chording keyboards which inevitably lead to hesitations and corrections of the designated combination.

They are in particular implementable by using the clearing process already described above with the “Bitap”, “Successitap” and “Simultaneous” processes, which consider as logically active the zones which have not been physically released and those which have been released only within a configurable threshold interval (tempo2 and tempo0), which characterize the clearing of a sensitive zone that was physically activated; all sensitive zones are logically deactivated after validation. This solution also makes it possible to clearly distinguish the sensitive zones that are part of the validated combination and those that aren't part of it.

In the case of “Bitap”, since the raising of the actuator from the second sensitive zone performs the validation, it is not possible to do the above exploration, unless the technology used for the sensitive zone allows gliding towards another sensitive zone without lifting the actuator or if a second actuator can activate another sensitive zone without having first raised the first actuator. In the case where “Bitap” is not implemented in a mixed process with “Successitap” or “Simultaneous”, it can be implemented so that leaving the actuator in contact with the sensitive zone for a period greater than a time delay (tempo5), is equivalent to stepping backward which is signaled to the user by returning to the previous presentation created after the first press, and authorizes the raising of the actuator without the validation taking place.

For a beginner, the presentation software puts visual emphasis on the activated sensitive zones and selected objects in step with the beginning user's interaction with the DEMD. This placement of emphasis is fundamental so the beginners know what they have already done to move towards the desired illustration and the associated object. This placement of emphasis is done according to the selected representation. For example, the placement of emphasis is done either in the form of successive screens (chaining of the FIGS. 10(a) 10(b) and 10(c)) or by putting in exergue, without distributing objects among the N sensitive zones, (FIGS. 10(g) and 10(h) or 11(h) to 11(j)), the group of objects sharing the same activated zones and then the designated object before validation (and if relevant stepping backward and abandoning). In the representation according to FIGS. 10(g) and 10(h), where the zoom function is not active or available, the emphasizing of the activated sensitive zones can be done by adding some indication with different colors in the grids (101 and 102) and putting emphasis on the designated object (103). Different colors can also make it possible to distinguish the object being designated and ready to be produced when the zone would be released (FIGS. 11(h), 11(i) and 11(j)).

In a configurable implementation, the presentation can only become active after the expiration of a time delay T4 (tempo4) starting with the activation of a first sensible zone, the passing of this time delay is interpreted as an hesitation on the part of the user. The presentation is therefore proposed as an aid, according to means configured by the user. Similarly the representation can fade out either right after validation or right after a time delay T3 (tempo3) and go to the background of the active window, and only return to the foreground when a sensitive zone is activated, either immediately for the beginner or after a configurable time delay T4 (tempo4) mentioned above. These options concern the beginner because, it has been observed that when user knows his clusters and tables, the constantly changing contents of the visual zones is disturbing, and he prefers either a transparent grid or no grid at all (sensitive zones not merged with visual zones).

If the visual zones are merged with the sensitive zones, (touch screen), then a minimal grid is enough, and the filling of the invention visual zones can be transparent, showing permanently on the whole screen the “content” that the application has to display (FIGS. 13 and 131). If the touch screen is multi touch, the user using at least 3 fingers and if the main apparatus CPU is powerful enough, the grid can also disappears and can be anywhere in the screen, the program computing the effective boundaries from the successive fingers which have hit the screen, and which are just supposed to belong to one immobile or slightly moving hand (to follow the input or editing process). Disambiguation software will of course be used when several conflicting options appears, but they would be proposed on a display grid which is above the area drummed by the fingers, as if the visual zones were no longer merged with the sensitive zones, but still on the same screen. Idem if the user hesitates and the T4 time out is reached.

Since learning efforts and their fears were what most blocked chording devices from emerging to the public at large, in a variant adaptive to the context, the visual presentation might not be made up as such, as a graphic block addition, which requires a certain visual shuttling between zones of the screen and, depending upon the transparency chosen for the interactive graphic more or less hides what is below, but be associated to the existing presentation of available commands. For example, the symbolic representations with checkerboards of the positions of the fingers on sensitive zones (FIGS. 26(a) and 26(c)), could be permanently or dynamically placed side by side with the fixed or scrolling icons and menus and different choices. In this manner, the beginner sees as he practices in the old way how he could, next time, uses only the movement of his fingers to produce a command.

As mentioned above, the visual presentation is one solution but not the only one. In particular, still in the context of the present invention, in case there is no screen, which corresponds to an advantageous use of the DEMD in social situations or while moving or during other observation activities, the presentation could be done in vocal or tactile form. In this latter case, the sensitive zones are each associated with a small tip which acts on the skin when the corresponding sensitive zone is activated, either statically once, or by vibrating. This tactile presentation is additionally interesting for being able to present information of any type when neither a screen nor an earphone are possible, technically or socially. This tactile presentation could be, in a specific embodiment, associated with a watchband or bracelet containing the core of a DEMD using light beams and not needing a dedicated rebound surface.

Hesitation—Cancellation

For a user who actuated a sensible zone in error, the DEMD can “clear” the sensitive zones designated in error once a time greater than the time delay T2 (tempo2) previously defined in the different processes for simultaneous releases, has passed after the user raised his finger from the incorrect zone, on the condition that there is still another sensitive zone assigned to a nimble finger which is physically activated, which can make it necessary to physically activate another zone assigned to a nimble finger before lifting the finger having an incorrect position. This possibility provides to the user an easy exploratory learning experience and also offers a reassuring errors tolerance for the beginner.

Among the possible corrections, when the user completely changes opinion before validation of an object that he started to designate, a cancellation function is possible. This can be implemented by a principal but non limiting mechanism: the active cluster, or the cluster from the active table which is active when no thumb or little finger are down, has at least one combination associated with this empty or Null object, created as an internal function of the DEMD for cancellation. For example, when the technology allows it, the special combination of pressing the six keys assigned to the three nimble fingers, or more generally, a combination easy to make by moving the fingers according to the clearing process. The user, after using correction, hesitation and clearing mechanisms described previously to decignate the “Null” object, and then by raising his actuators, does not produce any object. This particularity of the invention avoids the user having to correct the results of an unintended activation, which is often easy with modern software but not always, and most of the time costly in time and rhythm of work.

In an interesting variant, this Null function at the same time clears the memory containing information on the modifying and lock keys of all kinds in particular positions, which thereby leads to the return to a well-known reference situation which is unambiguous and has no offset between what the user believes and the system knows.

When the BackSpace function has its own sensitive zone, the Null function can be added to the object “BackSpace”. With this option, TO can be infinite, since by producing that super BackSpace, the user wipes the first sensitive zone activated in a BiTap mode.

Moreover, when objects are in fact macros, that is several signs or commands produced together, the super BackSpace function will erase or go backward all changes produced by the last object input. If the user want to edit slightly the predefined phrase, he has to make another production, for instance a Null production, to be able to erase some letters of the input predefined phrase without wiping the characters which are before the cursor new position.

Correction-Disambiguation-Prediction-Completion

Concerning correction, disambiguation, prediction and completion which are implemented in the DEMD, two aspects can be considered: the aspect of detection of the fingers and the semantic aspect of what was entered.

During the rapid entry of data by the user, they can perform an erroneous entry, much more so when the transition between certain pairs of objects is not obvious for untrained fingers. Thus the device includes material means by construction and configuration of the sensitivities, possibly even software, for correction of typing errors, in particular when taps are too short or force-less (too light touch). According to the present invention, the sensitive zones associated with a given finger are nearly totally mutually exclusive, except, in certain cases, for actions which are not done very quickly. Because of this, if the actuator acts inadvertently onto zones, the system gives priority to the first which is lightly touched, and in the case of a simultaneous light touch, to that where the force or the surface area, depending on the technologies, are larger. Basically, the sensitive zones adapted to the invention do not need, like conventional keyboard keys, to go past a threshold of movement nor to provide a sensation of collapse of resistance, and are, in contrast, activated by little or no movement for little or no force. In fact, first, the fingers which gallop at several taps per second would be slowed by these movements and forces, and further because the movements of the fingers are simple, there is no utility in discriminating between the desired key and its neighbors, as it is mandatory on standard keyboards, where the neighbors are nearly always brushed by touch typing with fingers moving over significant areas.

Further, in the case where the user has difficulty sequencing the production of a first object followed by a second object because his fingers position poorly and designate a third object by error, software means store this data in memory (sequencing object 1-object 2 delicate for this user) and provide means for easing and anticipating (therefore predicting and correcting) the errors: when the first object is produced, the logical zones associated with the second object can be enlarged to the detriment of those for the third object in order to facilitate the production of this second object.

Another way to reduce the errors is to propose unordered two finger processes. This is possible, as brought up previously, when entering text and meaningful words in a given language. The principle is called disambiguation and was made famous by the T9 technique from Tegic. It consists of not asking the user to produce exact letters but being satisfied to produce a code associated with two (Suretype) or three/four (T9 or iTap) or six letters (Tengo) and let the software and its vocabulary tables, remove the ambiguities by suggesting syllables or words that the user only needs to choose instead of typing them fully, which is not always advantageous with the existing systems, where people don't look permanently at the screen. In the case of the invention, if two keys among six are tapped simultaneously, each of the possible combinations can only correspond to two distinct arrangements by the typing order of the same two single keys, for example “B” and “J”, which corresponds to a low linguistic ambiguity, easy to deal with. Only one root or a single word will very often be the only possibility.

In the case of several choices, the fact that, with the chording keyboards and the current invention, one does not look at the keyboard, makes it possible to look only at the screen, and therefore to see immediately the system messages, and then with the dynamic guiding associated with the interactive presentation (already described), to present the choices in a manner to select them with a sensitive zone linked to the position of the choice in the dynamic guiding, as illustrated in FIG. 17, therefore, without having to go activate the arrows and OK keys, more or less distant: one sees and clicks, activating the sensitive zone associated with the visual zone where the preferred option suits him, which is then faster than finishing typing the word. As a matter of fact, main current disambiguation offerings can propose words with one or two more letters left to be entered, which is stupid, because the disturbance slows the user, or can be at pain to propose words which have really a strong probability to fit the user intention, or don't propose a “no” quick option to refuse all the proposed words.

With the current invention, and implementation 1, 6 visual zones, (FIG. 17), after typing 3 letters (171), the proposed words (172), should be no more than 5 with a “no” option (173), always in the same visual zone, and the probability to suit the user with the 5 proposed words high and beneficial (more than two letters gain). Otherwise the system should be wise enough and not disturb the user, maybe taking into account his typing and selection speeds, which are not the same for an expert, a beginner or a handicapped.

Therefore when disambiguation software is available for the language in which a text is being created, one can have a simultaneous press by two fingers, very easy and therefore rapid, and natural for a user having started in “Bitap” and then “Successitap”. In the context of disambiguation on only two elements, it is often also possible to proceed with automatic error corrections (elimination of words not having any meaning) or proposals so the user can correct himself by specifying during their typing the root or word that they really want in place of the incorrect root.

All mechanisms described above to propose words in a disambiguation function would work the same for correction and completion functions, which is now described.

Beyond disambiguation, the prior art also knows means for prediction and semantic completion based on dictionaries and the user's most frequent phrases, in particular put to use in portable telephones. By software means, the DEMD offers the user semantic suggestions as a function, for example, of the objects immediately entered, and a syntactic and semantic analysis from the beginning of the phrase entered, and from context (software) in which the DEMD is used. In that context, the active cluster present on the screen is modified to show the user one or several objects (words, portions of phrases, commands, etc.) proposed by the semantic or language prediction.

Alternatively, an optional cluster is created with one or several of these new objects and presented to the user in a favorable area of the screen. In particular this is the case in FIG. 17 which shows five proposals (172) which can be designated following the entry of the beginning of the word “Per” (171). This modified or created cluster is presented to the user visually or by any other means, if the user desires it. Thus the latter can effectively produce the desired object more quickly if this is made part of the suggestions; whereas often with conventional systems, selecting a suggestion (with arrows keys or a pointer not under your fingers), is slower than finishing typing the letters of the intended word without considering that if the user looks at the keys the user doesn't see the suggestion very early.

When the screen is large enough and the choices aren't too numerous, the suggested objects are presented in the visual zones of a large domino in a manner that the selection of the preferred object can be done by an action of the fingers analogous to that of the production of the elementary objects remaining to be added to achieve a semantically correct word or phrase which is suited to the thought wanted by the user. This presentation gets its interest by the fact that the user of the DEMD according to the invention never looks at his hands or the DEMD, and is trained to mimetically interpret the symbolic representations and activate the associated sensitive zones rapidly.

This compact and easy to designate presentation applies to words and standard phrases. To facilitate the production of repetitive, conventional or typical texts, the symbolic presentation could carry on the clusters where the phrases are represented by icons which, when selected, display the phrase, for instance in the helper zone if it is too long for the visual zone itself, and then input it as a whole when the corresponding sensitive zones are released.

This method has a meaning with the invention because the user can keep looking at the screen and call at will various clusters of specific and personal objects. In the case brought up, the production of text is greatly accelerated and corresponds well to the contexts of Instant Messaging or text messages.

The helper zone (FIG. 11, 112x, or FIG. 12(b) 122), may be useful to indicate, for example, the type of cluster that is used (before the first actuation), or the objects that are going to be selected (after the first actuation and before the second actuation). This helper zone is shown in FIG. 12(b), comparatively with the FIG. 12(a) where the helper zone (121) is deactivated. Referring to FIG. 12(b), this helper zone (122) is positioned just above the visual zones to allow the user to have simultaneously a look at the visual zones and the helper zone. On FIGS. 11(a) to 11(d) the successive 112x display the cluster name 112a, the first zone content 112b, the selected object 112c and again the cluster name 112a.

Automatic Configuration and Adaptation

According to an embodiment, the device includes software modules for the management of the steps and mechanisms previously described. This in particular makes it possible to offer a user configuration interface as a function of these objectives:
Choice of the time-delay threshold durations:
   T0=tempo0, in pure Bitap mode, defines the time available to the user for moving the single actuator from the first sensitive zone to the second.
   T1=tempo1 for the separation time between simultaneous and successive action on two sensitive zones.
   T2=tempo2 for the clearing time delay for physically released zones, both to keep together sensitive zones which are not released fully simultaneously and to allow oblivion and exploration.
   T3=tempo3 for managing the fading delay for the interactive guiding when user is not typing.
   T4=tempo4 for managing the reappearance of a guiding visualization when the user hesitates before validating or adding a finger.
   T5=tempo5 for the automatic clearing of the second Bitap press, and to allow releasing zones without any production.
   T6=tempo6 for the clearing of pointer movements before the inhibition triggered by the activation of one of the DEMD sensitive zones.
   T7=tempo7 for the automatic second actuation of the same zone when the user maintain the actuator on the first actuated zone of a pivot object.

Choice of transparency levels for the interactive visualization, either for the whole system of each cluster differently, in accordance to learning stages and usage frequencies
Choice of the preferred designation and confirmation modes (Bitap, Slide, Successitap, Simultaneous, Mixed, Advanced, etc.).
Configuration of the logical sensitive zones as a function of the morphology of the user's hand.
Choice of actuators.
Configuration of the tables/clusters (nature and items of the objects, positioning of the objects according to preferences).

System

In an embodiment illustrated by FIG. 5, the DEMD devices (52, 53 and 54) are connected by a wired connection (52) (USB cable, network cable) or wireless connection (53 or 54) (infrared, Bluetooth, WiFi, RF, etc.) to the equipment (51) where the data is entered.

In an implementation the DEMD includes software means making it possible to implement the method described in the present invention and communicate with the equipment to which it is connected. Similarly, the equipment includes software means and can communicate with the DEMD and interpret the data sent for executing an action for example.

The user, who wishes to perform an action on the equipment in question, produces the combination corresponding to the desired action by means of the DEMD. The DEMD transmits to the equipment some data which are interpreted by the equipment for producing the action. According to the possibilities for installing programs and putting tables implementing the invention in memory, or accessing hardware services means, a smaller or larger share, possibly null, of the method according to the invention will be done in the equipment, and the DEMD will do what cannot be done by this equipment.

In a particular embodiment, several DEMD can concurrently drive a single equipment. Such a scenario in particular makes game, conference, or shared work session applications possible. This system has certain advantages: for a single person, but also for several people working or playing together by sharing only a local or duplicated screen and applications, where each is able to take part from their place all while easily watching what happens on the shared screen. Although, that is also feasible with conventional keyboards, the use of the DEMD according to the invention provides significant advantages, in particular the fact that only one hand is used for either entry, commands and pointing. Another advantage concerns the fact that the possible physical positions for the participants are more comfortable and more varied (less need for tables, standing positions and moving around made possible, etc.) and since the users do not need to look even furtively at the keyboard they can concentrate on what is shown on the shared screen or in the attentive global listening to the one who is talking.

A particular case relates to the case where two DEMD (FIGS. 5, 56 and 55), potentially with different architectures, are connected and handled by each of the hands of a single user (user 3 from FIG. 5), thus putting up to 10 actuators into play. This configuration which will only involve users already experts with each hand will allow, in particular but not necessarily, making the typing of two successive signs totally independent, whereas on the conventional two-handed keyboards the independence is below 80%. Combined with ad hoc semantic correction and prediction software, possibly also by using phonetic syllables clusters (only several tens in French compared to more than a thousand for orthographically correct writing) this system could be more productive than the fastest which currently exists: Qwerty-Azerty, direct Stenotype and VeloType (company's name).

The DEMD can also be an independent device having its own calculation means (interpretation software for the sensor, management software for the tables, etc.) and possibly means for presentation of the object produced by the user: specific visualization screen, for example fixed on the back of the hand which acts on the DEMD, external visualization screen, sonic presentation means (voice synthesizer, speaker, headphones, earpieces, etc.), means for tactile presentation, etc.

In contrast, the DEMD could be part of a client/server architecture in which the program implementing the current invention is downloaded to the client apparatus, via the network/Internet connection (57), for instance carried by an Internet browser. In a specific implementation, the DEMD includes the sensitive detection means (sensors), presentation means (a screen, speaker), network communication means (for example, WiFi, GSM or UMTS), software means making the human machine interface (HMI) and data transmission on the network possible. In this embodiment, the DEMD is only one Human Machine Interface and the application services for the method are remoted to a server (58), connected to the network. This DEMD could be either personal or shared, or specific to a given site and context, according to the state-of-the-art for terminals. Thus, the personalization data (objects, contents and structure of the clusters, sizing of the sensitive zones, etc.) are stored on the server (58) and only the coordinates of the actuators determined through the sensor(s) are transmitted to the server. Real-time use, meaning fluid use comparable to the production of a normal user, can be achieved on current high-performance communication networks (Ethernet, GPRS, UMTS-3G, HSPA, WiFi, WiMax, etc.).

As a variant, user parameters and customized programs are temporarily installed in the DEMD terminal (51) according to the state-of-the-art of the terminals and servers.

DEMD+Screen

In a particular embodiment, but a classical use in the state-of-the-art, the DEMD is connected to at least one display screen. The display screen makes it possible to enrich the DEMD with useful modules for learning and using this combinatorial data entry device. Spectacles screens are becoming available and lack a DEMD you don't have to look at.

Even more favorable variants for use in mobility situations will associate the DEMD with voice synthesis and audio presentation via an earphone, much less intrusive for third parties than a screen. The least intrusive is the tactile presentation on a large enough area of skin, for example on the wrist in a bracelet potentially associated with the core of the detection device.

### Implementation Example 1

### DEMD Integration into a Portable Telephone

A specific application for the DEMD relates to mobile telephones which are becoming more and more terminals and therefore need a Human Machine Interface going beyond the historic 12 keys, 4 arrows, “enter” and “escape” keys.

According to the choice of the manufacturer or later by the user, five main embodiments are possible with the DEMD according to the invention:
Installation1 limited to the software implementing the process according to the invention and based on 6+4+2 keys taken on a standard numeric keypad, for example, according to FIG. 18. Only the Bitap and Successitap modes for two thumbs are practically possible because of the pressing hardness of standard keys. But this already makes possible a flexible software keyboard for input and commands without looking at the keys at all, much faster and more sophisticated than the conventional keypads and processes. In the example from FIG. 18, and with the grammar from FIG. 7(a), the usual mobile telephone keys are used and pressing the keys “1” then “2” produces the letter “B”. Therefore, this software implementation provides the power and flexibility of a virtual keyboard without requiring having to install a more costly and fragile touch screen. It is particularly advantageous to add “functions keys” which are really lacking on a 12 keys pad, either inside some clusters or with the remaining 6 keys.

Installation2 of a type 1 implementation based on touchpad multi-touch technologies by replacing only the cursor manager according to FIG. 19. The DEMD band is the width of the telephone and 1 to 2 cm high. It can be used in Bitap, Slide, Successitap, Tritap, Simultap, Mixed and Advanced according to whether the user has one hand or two to hold and operate its apparatus. The DEMD makes it possible to do and accelerate all a telephone's HMI actions. In the example from FIG. 19, the cluster (191) is used in glide mode. For this purpose, the glide (192) between the two positions “front left” and “front center” produces for example the letter “B”.
Installation3 of a type 2 implementation based on commercial touchpad technologies, according to FIG. 20. The multi-touchpad covers all or part of the telephone's non-screen surface. The classic keys are shown on the surface and can be activated by simple software switch. In DEMD mode according to the invention, a simple software addition, it allows the uses of implementation1 plus the use with four or five fingers, right or left hand, and use of a mouse. The manufacturer can in particular significantly increase the already common, according to the state-of-the-art, universal wireless remote control functionalities of their phone, currently limited and slow because of the constraints of conventional keyboards for mobile objects. With the DEMD according to the invention, the telephone can then really act very powerfully and quickly on all the electronic apparatus carried by the person and those that he encounters.
Installation4 of a type 1 or 2 implementation directly on the touch screen (FIG. 22(a)), either mono-touch only allowing Bitap or Glide presses with fingers or stylus, or multi-touch and also allowing Successitap and simultaneous advanced uses.
Finally, installation5, the user can obtain directly from the manufacturer or from a separate DEMD supplier, a DEMD according to the invention, distinct from the telephone (22(c)), and acting on it remotely or re-integrated with it through a sleeve and ad hoc connections according to the state-of-the-art, and situations corresponding to FIG. 5.
For all installations, the software can be in the network, in the apparatus or in the device accessory or all, depending on the context and the ownership levels of the user on the devices it brings with him or he uses in a given place.

### Implementation Example 2

### DEMD Implementation with Authentication and Identification

The DEMD is an electronic object which communicates with external means. When these are not passive and can communicate with the DEMD and control what it transmits, it is advantageous to include in the electronic system of the DEMD authentication means for the DEMD and Identification of the user communicating with these external means according to processes which users cannot, according to the state-of-the-art, bypass.

For example the DEMD can integrate an electronic security chip through which the DEMD can pass when it receives specific requests after having or before having inserted user entered information.

Further, as is known from the state-of-the-art, the manner of moving the fingers can characterize a given individual fairly strongly. In such an implementation, beyond the underlying dialogue of the electronic chip authenticating the DEMD object which is connected, this system can add in an automated manner, without calling on the user, regular verifications of the identity of the current user. This new solution would be juxtaposed, for security risks defined by the ad hoc managers, to conventional requests for entry of information that the user alone is deemed to know and protect from disclosure, or placing a finger on a biometric reader. By integrating the authentication and identification means for a person in a personal DEMD that this person transports and uses voluntarily for his own personal reasons, the objects called “Tokens” by the state-of-the-art are made much more comfortable and acceptable to use. This way, the DEMD according to the invention makes it much easier to substantially increase the security on networks and mobile phones, by replacing the “log in”+“password” combination whose well-known weaknesses have not stopped it from remaining dominant, because of the heavy constraints of the Tokens (they require wearing a specific object which interrupts work).

The security enabled by the current invention implemented in tokens, concerns, with of course the ad hoc CPU, memory and encryption keys management, the authentication, the identification, the exchanged data encryption, the data stored and the messages encryption towards dedicated receivers and without any repudiation possibility.

By applying the above implementations to telephone networks and mobile IT networks (fixed, DECT, GSM, CDMA, UMTS3G, 4G-LTE etc.), it appears that the chip which is currently kept fairly immobile in a given terminal, can logically be taken out of it and create much more flexible conditions for use of all sorts of terminals, personal or made available by third parties and for access to protected locations, through a personal DEMD, provided with means of authentication and identification that the person uses any way quite naturally and frequently because he decided personally and freely to always have it with him for all the benefits it brings to him. Otherwise, the mobile phone and its chip can take control of other devices, including phones and terminals and act as a token for that needs.

### Implementation Example 3

### DEMD Implementation According to the Available Technology

The DEMD may be implemented towards a display screen in different ways. In particular, in the case the display screen is a touchscreen, the DEMD may be merged with the touchscreen, as illustrated in FIG. 22(a). In another case, when the display screen is not a touch screen, the DEMD may be integrated in the same block as the display screen and next to it, as shown on FIG. 22(b). These two arrangements allow the user to look at the display screen and at the DEMD at the same time, and so the user can input data or objects more easily.

In another embodiment, referring to FIG. 22(c), the DEMD is remote from the display screen, in order to allow the user to input directly by having the remote DEMD in his hand, which may be for example in his pocket.

Referring now to FIGS. 23(a) to 23(c), the DEMD may be a multi-touch surface (FIG. 23(a)), a keypad containing a plurality of keys (FIG. 23(b)) or a pointer controlling a cursor, for example the mouse of a computer (FIG. 23(d)), but any pointer can do.

The DEMD may also be implemented according to the use that the user may have, for example with one or two hands. For a use with only one hand, there are many possibilities:
the DEMD is integrated to the display screen and designed to be held by one hand and the thumb of this hand makes the input (FIG. 24(a)),
the DEMD is integrated to the display screen and designed to be put on a support and any finger of one hand can make the input (FIG. 24(b)),
the DEMD is controlled by a mouse (FIG. 24(c)),
the DEMD is remote and designed to be put against the body of the user whose any finger of one hand can make the input (FIG. 24(d)).

For a use with the two hands of the user, there are also many possibilities:
the DEMD is integrated to the display screen and designed to be held by one hand and to be inputted by the other hand (FIG. 25(a)),
the DEMD is integrated to the display screen and designed to be held by the two hands and to be inputted by the thumb of each hand for a faster inputting (FIG. 25(b)),
the DEMD is designed to be arranged on one arm of the user and to be inputted by any finger of the hand of the other arm (FIG. 25(c)),
the DEMD is separated into two remote clusters that may be put against the body of the user whose any finger of each hand can make the input (FIG. 25(d)),
the DEMD is integrated to the display screen and designed to be held by one hand and to be inputted by a stylus that is held by the other hand (FIG. 25(e)).

It is to be understood that the skilled person in the art will be able to find other ways to implement the DEMD according to the technology and these other ways are therefore within the scope of this invention.

It is also to be understood that the invention is not intended to be restricted to the details of the above embodiments, which are described only by way of example. Various modifications will become apparent to those skilled in the art and are within the scope of this invention, which is defined more particularly by the attached claims.

In particular, the here above method and device may be implemented with any number of sensitive zones different from 6, like for example 7, 8, 9, or 12.

### Implementation Example 4

### DEMD Implementation According to the Available Internet Technology

It started many years ago, but the distributed computing and programs distribution via the Internet and the meta application called a browser and the many small meta programs like widgets, scripts, booklets exploiting the way an Internet page is coded now can go a step further with the current invention.

Thanks to the invention visual zones global smallness or transparency and contextual filling, many powerful services become smartly possible without annoying users, in the same unified and personalized User Interface, look and feel, on all devices used with a browser, without needing a standard keyboard, nor drop down menus nor complicated, endless and fuzzy navigations.

The generic term for programs which are added to a browser is “Booklet”. They may be used, through DEMD objects that are services provided by third parties program or service providers according to a minimal inscription or subscription by the user, the display presentation order being either dynamically determined or built by the user.

When the method allows the appearance of the full guiding display screen or any of the previously visual zones, the user may have the ability to make the zones appear or disappear in a single operation: a click on a zone, a button or an image inside or outside the application (including browser bookmarks), or change the status and look&feel of such zones (for example, size, colors, fonts, design, transparency and position on the screen). The appearance and initial state of the screen and zones may be controlled and guided by rules and preferences selected by the user on events raised by the programs or by visited page or by themselves. The appearance of the zones may be also controlled and decided by a program or a script embedded in a web page according to a given use or on given event.

In a particular embodiment, one or several additional display zones are displayed on the display screen or somewhere else in the screen with information (text, link, form, image, sound video or any available rich media now and in the future), local or retrieved through network connection, related or not with the content being selected by the user, the user himself, any contextual information available when the actuation occurs (date, apparatus environment, open applications, etc. . . . ).

In another particular embodiment, one or several existing display zones in the “background” program or webpage on which the method is used are dynamically filled or complemented with information (text, link, form, image, sound, video or any available rich media now and in the future), local or retrieved through network connection, related or not with the content being selected by the user, any contextual information available when the actuation occurs (date, apparatus environment, open applications, etc. . . . ).

The distant computer program or website may also allow the final user or service/program host server to manage its personal information and parameters, options, subscription or activation of additional services embedded or not as objects in the display screen later used by any program or apparatus implementing the above described method.

1. A method for inputting any object among a set of up to N*N objects to an apparatus with a data and commands input system comprising N sensible zones and a display screen on which there are N delineated visual zones, N being an integer above 3, each object having a symbolic representation, the visual zones being associated one by one with the sensible zones, the method comprising:
a first display of N visual zones each containing an indication for a subset of up to N objects of the set of up to N*N objects;
a first actuation of a sensible zone associated with a visual zone containing an indication of an object to be selected among the subset of up to N objects;
a second display of N visual zones, in response to the first actuation of the sensible zone, to display the symbolic representations of the up to N objects of the subset indicated in the visual zone associated with the first actuated sensible zone;
a second actuation of the sensible zone relatively positioned as the symbolic representation indicative of the object to be selected is positioned in visual zone(s),
wherein:
the N visual zones are displayed in the same relative positions and forms as the N sensible zones,
before the first actuation, all the symbolic representations are arranged in each visual zone so that:
all said symbolic representations indicative of the up to said N*N objects are displayed, up to N in each visual zone,
the relative positioning of up to N symbolic representations in each visual zone is the same as the one of the N visual zones on the display screen,
the up to N objects of each visual zone are positioned on an oriented curved line, linking up to N positions arranged in the corresponding visual zone in similar positions as the visual and sensitive zones, by following a pre-set order of the subset of up to N objects, and
in each of the N visual zones, the object which is selected by first and second actuations of the same sensible zone is also the first object of the corresponding subset of up to N objects, according to the pre-set order of said subset, after the first actuation, the up to N symbolic representations initially displayed in the visual zone associated with the actuated sensible zone are now positioned in the N visual zones so that their resulting relative positioning is the same as the relative positioning of the symbolic representations initially displayed before the first actuation.

2. The method of claim 1, wherein the visual zone associated with the first actuated sensible zone and the up to N objects of the subset in the first visual zone are put in some exergue indicative of the first actuation.

3. (canceled)

4. The method of claim 2, wherein the putting in exergue of the display zone associated with the first actuated sensible zone and of the up to N objects of the subset in the first visual zone and the second display are produced as soon as a sensible zone is first actuated.

5. The method of claim 2, wherein the putting in exergue of the display zone associated with the first actuated sensible zone and of the up to N objects of the subset in the first visual zone and the second display are produced when the first actuated sensible zone is released.

6. The method of claim 1, wherein the selected object is inputted to the apparatus when the second actuated sensible zone is released.

7. The method of claim 1, wherein the second actuation is obtained by gliding the actuator which has first actuated the first sensible zone to the second sensible zone corresponding to the initial position in the first actuated sensible zone of the symbolic representation indicative of the object to be selected.

8. The method of claim 1, wherein the second actuation is obtained by maintaining with a first actuator the first actuated sensible zone and by actuating with a second actuator the second sensible zone corresponding to the initial position in the first actuated sensible zone of the symbolic representation indicative of the object to be selected, and wherein the inputting of the selected object to the apparatus is obtained by releasing said first and second actuators.

9. The method of claim 1, wherein the oriented curved line is built according to trigonometric inverse order.

10. The method of claim 1, wherein the first actuation drops out after a threshold time delay.

11. The method of claim 1, wherein the first and second activations drop out by tapping or gliding an actuator outside the sensible zones and releasing said actuator after other sensible zones have been released.

12. (canceled)

13. (canceled)

14. (canceled)

15. (canceled)

16. The method of claim 1, wherein a first threshold time delay allows to separate between simultaneous and successive activation of two sensible zones, and a second threshold time delay allows to forget deactivated sensible zones and not take them into account to compute what is displayed, put in exergue in the display zones and input in the apparatus when all sensible zones are found released.

17. The method of claim 1, wherein addition of a third sensitive zone to disambiguate between two combinations using a same pair of sensitive zones is guided on the display zones, before any activation, after simultaneous press of two zones and after the addition or release of the sensitive third zone.

18. The method of claim 1, wherein the set of up to N*N objects includes at least one among a set of computer and electronic objects, alphanumeric characters, words, signs, standard phrases, icons, scrolling menu items, commands and programs internal to the apparatus, commands, programs and services stored with their parameters and provided by at least one among a third party program and service providers external to the apparatus and residing on any other apparatus, computer and electronic equipment to which the apparatus is connected, or through smart personal widgets working via a browser and Internet connections to ad hoc servers and analyzing the user actions on sensible zones and Internet pages.

19. (canceled)

20. (canceled)

21. The method of claim 1, further including creating a cluster of suggestions including at least one and up to N−1 suggestions, said cluster being displayed in the N visual zones, the selection among the suggestions being made by actuating and releasing the sensible zone associated with the visual zone where the suggestion that suits the user is displayed.

22. The method of claim 1, wherein the appearance and fading out of the visual zones is controlled by one among computer programs, parameters chosen by the user and scripts or events embedded in a web page when the apparatus is connected to a web page.

23. (canceled)

24. A device for inputting to an apparatus any object among a set of up to N*N objects, comprising N sensible zones and a display screen on which there are N delineated visual zones, N being an integer above 3, each object having a symbolic representation, the visual zones being associated one by one with the sensible zones, the device making it possible to execute the method comprising:
a first display of N visual zones each containing an indication for a subset of up to N objects of the set of up to N*N objects;
a first actuation of a sensible zone associated with a visual zone containing an indication of an object to be selected among the subset of up to N objects;
a second display of N visual zones, in response to the first actuation of the sensible zone, to display the symbolic representations of the up to N objects of the subset indicated in the visual zone associated with the first actuated sensible zone;
a second actuation of the sensible zone relatively positioned as the symbolic representation indicative of the object to be selected is positioned in visual zone(s), wherein:
the N visual zones are displayed in the same relative positions and forms as the N sensible zones,
before the first actuation, all the symbolic representations are arranged in each visual zone so that:
all said symbolic representations indicative of the up to said N*N objects are displayed, up to N in each visual zone, o the relative positioning of up to N symbolic representations in each visual zone is the same as the one of the N visual zones on the display screen,
the up to N objects of each visual zone are positioned on an oriented curved line, linking up to N positions arranged in the corresponding visual zone in similar positions as the visual and sensitive zones, by following a pre-set order of the subset of up to N objects, and
in each of the N visual zones, the object which is selected by first and second actuations of the same sensible zone is also the first object of the corresponding subset of up to N objects, according to the pre-set order of said subset, after the first actuation, the up to N symbolic representations initially displayed in the visual zone associated with the actuated sensible zone are now positioned in the N visual zones so that their resulting relative positioning is the same as the relative positioning of the symbolic representations initially displayed before the first actuation.

25. (canceled)

26. (canceled)

27. The device of claim 24, wherein relative positions of sensible zones are arranged under one hand and under fingers so that each sensible zone can be reached without moving the hand but only the fingers.

28. (canceled)

29. The device of claim 24, wherein the sensible zones are a part of the area of the visual zones.

30. (canceled)

31. The device of claim 24, wherein the sensible zones are separated from the main part of the apparatus to be used at a distance from said main part of the apparatus.

32. (canceled)

33. (canceled)

34. The device of claim 24, further including a pointer mechanism built with technologies among the actuators positions detectors of the device, a juxtaposed pointer device and a mouse device under the DEMD device.

35. (canceled)

36. (canceled)
